(19) United States
(12) Patent Application Publication
(10) Pub. No.: US 2009/0094047 A1
(43) Pub. Date: Apr. 9, 2009

(54) Systems and methods for predicting a risk utilizing epigenetic data

(75) Inventors: Roderick A. Hyde, Redmond, WA (US); Edward K.Y. Jung, Bellevue, WA (US); Jordin T. Kare, Seattle, WA (US); Eric C. Leuthardt, St. Louis, MO (US); Dennis J. Rivet, Portsmouth, VA (US); Lowell L. Wood, JR., Bellevue, WA (US)

Correspondence Address: IV - SUITER SWANTZ PC LLO, 14301 FNB PARKWAY , SUITE 220, OMAHA, NE, 68154, US

(73) Assignee: Searete LLC, a limited liability corporation of the state of Delaware

(21) Appl. No.: 12/079,589

(22) Filed: Mar. 27, 2008

Related U.S. Application Data
(63) Continuation-in-part of application No. 11/906,995, filed on Oct. 4, 2007.
Application No. 11/906,995 is a continuation-in-part of application No. 11/974,166, filed on Oct. 11, 2007.
Application No. 11/974,166 is a continuation-in-part of application No. 11/986,967, filed on Nov. 27, 2007.
Application No. 11/986,967 is a continuation-in-part of application No. 11/986,986, filed on Nov. 27, 2007.
Application No. 11/986,986 is a continuation-in-part of application No. 11/986,966, filed on Nov. 27, 2007.
Application No. 11/986,966 is a continuation-in-part of application No. 12/004,098, filed on Dec. 19, 2007.
Application No. 12/004,098 is a continuation-in-part of application No. 12/006,249, filed on Dec. 31, 2007.
Application No. 12/006,249 is a continuation-in-part of application No. 12/012,701, filed on Feb. 5, 2008.

(51) Int. Cl. G06Q 99/00

(52) U.S. Cl. 705/1

(57) ABSTRACT

A method includes receiving epigenetic information associated with at least a specific individual and/or prognosticating a risk at least partially based on the epigenetic information associated with at least a specific individual and the at least one correlation of epigenetic information associated with at least a first individual for at least a first epigenetic-information interval of time with disability data associated with at least a first individual for at least a first disability-data interval of time.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)).

### RELATED APPLICATIONS

For purposes of the USPTO extra-statutory requirements, the present application constitutes a continuation-in-part of U.S. patent application Ser. No. 11/906,995, entitled SYSTEMS AND METHODS FOR UNDERWRITING RISKS UTILIZING EPIGENETIC INFORMATION, naming Roderick A. Hyde, Jordin T. Kare, Eric C. Leuthardt, Dennis J. Rivet, Michael A. Smith; and Lowell L. Wood, Jr. as inventors, filed Oct. 4, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/974,166, entitled SYSTEMS AND METHODS FOR UNDERWRITING RISKS UTILIZING EPIGENETIC INFORMATION, naming Roderick A. Hyde, Jordin T. Kare, Eric C. Leuthardt, Dennis J. Rivet, Michael A. Smith; and Lowell L. Wood, Jr. as inventors, filed Oct. 11, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/986,967, entitled SYSTEMS AND METHODS FOR ANONYMIZING PERSONALLY IDENTIFIABLE INFORMATION ASSOCIATED WITH EPIGENETIC INFORMATION, naming Roderick A. Hyde, Jordin T. Kare, Eric C. Leuthardt, Dennis J. Rivet, Michael A. Smith; and Lowell L. Wood, Jr. as inventors, filed Nov. 27, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/986,986, entitled SYSTEMS AND METHODS FOR TRANSFERRING COMBINED EPIGENETIC INFORMATION AND OTHER INFORMATION, naming Roderick A. Hyde, Jordin T. Kare, Eric C. Leuthardt, Dennis J. Rivet, Michael A. Smith; and Lowell L. Wood, Jr. as inventors, filed Nov. 27, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/986,966, entitled SYSTEMS AND METHODS FOR REINSURANCE UTILIZING EPIGENETIC INFORMATION, naming Roderick A. Hyde, Jordin T. Kare, Eric C. Leuthardt, Dennis J. Rivet, Michael A. Smith; and Lowell L. Wood, Jr. as inventors, filed Nov. 27, 2007, which is currently co-pending, or is an application of which a currently co-pending application is entitled to the benefit of the filing date.

For purposes of the USPTO extra-statutory requirements, the present application constitutes a continuation-in-part of U.S. patent application No. 12/004,098, entitled SYSTEMS AND METHODS FOR CORRELATING EPIGENETIC INFORMATION WITH DISABILITY DATA, naming Edward K. Y. Jung, Roderick A. Hyde, Jordin T. Kare, Eric C. Leuthardt, Dennis J. Rivet; and Lowell L. Wood, Jr. as inventors, filed Dec. 19, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/006,249, entitled SYSTEMS AND METHODS FOR CORRELATING PAST EPIGENETIC INFORMATION WITH PAST DISABILITY DATA, naming Edward K. Y. Jung, Roderick A. Hyde, Jordin T. Kare, Eric C. Leuthardt, Dennis J. Rivet; and Lowell L. Wood, Jr. as inventors, filed Dec. 31, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/012,701 entitled SYSTEMS AND METHODS FOR COMPANY INTERNAL OPTIMIZATION UTILIZING EPIGENETIC DATA, naming Edward K. Y. Jung, Roderick A. Hyde, Jordin T. Kare, Eric C. Leuthardt, Dennis J. Rivet; and Lowell L. Wood, Jr. as inventors, filed Feb. 5, 2008, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### SUMMARY

In one aspect, a method includes but is not limited to receiving epigenetic information associated with at least a specific individual, receiving at least one correlation of epigenetic information associated with at Least a first individual for at least a first epigenetic-information interval of time with disability data associated with at least a first individual for at least a first disability-data interval of time, and/or prognosticating a risk at least partially based on the epigenetic information associated with at least a specific individual and the at least one correlation of epigenetic information associated with at least a first individual for at least a first epigenetic-information interval of time with disability data associated with at least a first individual for at least a first disability-data interval of time. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein—referenced method aspects depending upon the design choices of the system designer.

In one aspect, a system includes but is not limited to means for receiving epigenetic information associated with at least a specific individual, means for receiving at least one correlation of epigenetic information associated with at least a first individual for at least a first epigenetic-information interval of time with disability data associated with at least a first individual for at least a first disability-data interval of time, and/or means for prognosticating a risk at least partially based on the epigenetic information associated with at least a specific individual and the at least one correlation of epigenetic information associated with at least a first individual for at least a first epigenetic-information interval of time with disability data associated with at least a first individual for at least a first disability-data interval of time. In addition to the foregoing, other method aspects are described in the claims, drawings, and text forming a part of the present disclosure.

In one aspect, a system includes but is not limited to circuitry for receiving epigenetic information associated with at least a specific individual, circuitry for receiving at least one correlation of epigenetic information associated with at least a first individual for at least a first epigenetic-information interval of time with disability data associated with at least a first individual for at least a first disability-data interval of time, and/or circuitry for prognosticating a risk at least partially based on the epigenetic information associated with at least a specific individual and the at least one correlation of epigenetic information associated with at least a first individual for at least a first epigenetic-information interval of time with disability data associated with at least a first individual for at least a first disability-data interval of time. In addition to the foregoing, other method aspects are described in the claims, drawings, and text forming a part of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1 illustrates an exemplary environment in which one or more technologies may be implemented.

FIG. 2 illustrates an operational flow representing example operations related to prognosticating a risk at least partially based on the epigenetic information associated with at least a specific individual and the at least one correlation of epigenetic information associated with at least a first individual for at least a first epigenetic-information interval of time with disability data associated with at least a first individual for at least a first disability-data interval of time.

FIG. 3 illustrates an alternative embodiment of the operational flow of FIG. 2.

FIG. 4 illustrates an alternative embodiment of the operational flow of FIG. 2.

FIG. 5 illustrates an alternative embodiment of the operational flow of FIG. 2.

FIG. 6 illustrates an alternative embodiment of the operational flow of FIG. 2.

FIG. 7 illustrates an alternative embodiment of the operational flow of FIG. 2.

FIG. 8 illustrates an alternative embodiment of the operational flow of FIG. 2.

FIG. 9 illustrates an alternative embodiment of the operational flow of FIG. 2.

FIG. 10 illustrates an alternative embodiment of the operational flow of FIG. 2.

FIG. 11 illustrates an alternative embodiment of the operational flow of FIG. 2.

FIG. 12 illustrates an alternative embodiment of the operational flow of FIG. 2.

FIG. 13 illustrates an alternative embodiment of the operational flow of FIG. 2.

FIG. 14 illustrates an alternative embodiment of the operational flow of FIG. 2.

FIG. 15 illustrates an alternative embodiment of the operational flow of FIG. 2.

FIG. 16 illustrates an alternative embodiment of the operational flow of FIG. 2.

FIG. 17 illustrates an alternative embodiment of the operational flow of FIG. 2.

FIG. 18 illustrates an alternative embodiment of the operational flow of FIG. 2.

FIG. 19 illustrates an alternative embodiment of the operational flow of FIG. 2.

FIG. 20 illustrates an alternative embodiment of the operational flow of FIG. 2.

FIG. 21 illustrates an alternative embodiment of the operational flow of FIG. 2.

FIG. 22 illustrates an alternative embodiment of the operational flow of FIG. 2.

FIG. 23 illustrates an alternative embodiment of the operational flow of FIG. 2.

FIG. 24 illustrates an alternative embodiment of the operational flow of FIG. 2.

FIG. 25 illustrates an alternative embodiment of the operational flow of FIG. 2.

FIG. 25A illustrates an alternative embodiment of the operational flow of FIG. 2.

FIG. 25B illustrates an alternative embodiment of the operational flow of FIG. 2.

FIG. 25C illustrates an alternative embodiment of the operational flow of FIG. 2.

FIG. 25D illustrates an alternative embodiment of the operational flow of FIG. 2.

FIG. 25E illustrates an alternative embodiment of the operational flow of FIG. 2.

FIG. 25F illustrates an alternative embodiment of the operational flow of FIG. 2.

FIG. 25G illustrates an alternative embodiment of the operational flow of FIG. 2.

FIG. 25H illustrates an alternative embodiment of the operational flow of FIG. 2.

FIG. 25I illustrates an alternative embodiment of the operational flow of FIG. 2.

FIG. 25J illustrates an alternative embodiment of the operational flow of FIG. 2.

FIG. 25K illustrates an alternative embodiment of the operational flow of FIG.2.

FIG. 25L illustrates an alternative embodiment of the operational flow of FIG. 2.

FIG. 25M illustrates an alternative embodiment of the operational flow of FIG. 2.

FIG. 25N illustrates an alternative embodiment of the operational flow of FIG. 2.

FIG. 25O illustrates an alternative embodiment of the operational flow of FIG. 2.

FIG. 26 illustrates an alternative embodiment of the operational flow of FIG. 2.

FIG. 27 illustrates an alternative embodiment of the operational flow of FIG. 2.

FIG. 28 illustrates an alternative embodiment of the operational flow of FIG. 2.

FIG. 29 illustrates an alternative embodiment of the operational flow of FIG. 2.

FIG. 30 illustrates an alternative embodiment of the operational flow of FIG. 2.

FIG. 31 illustrates an alternative embodiment of the operational flow of FIG. 2.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

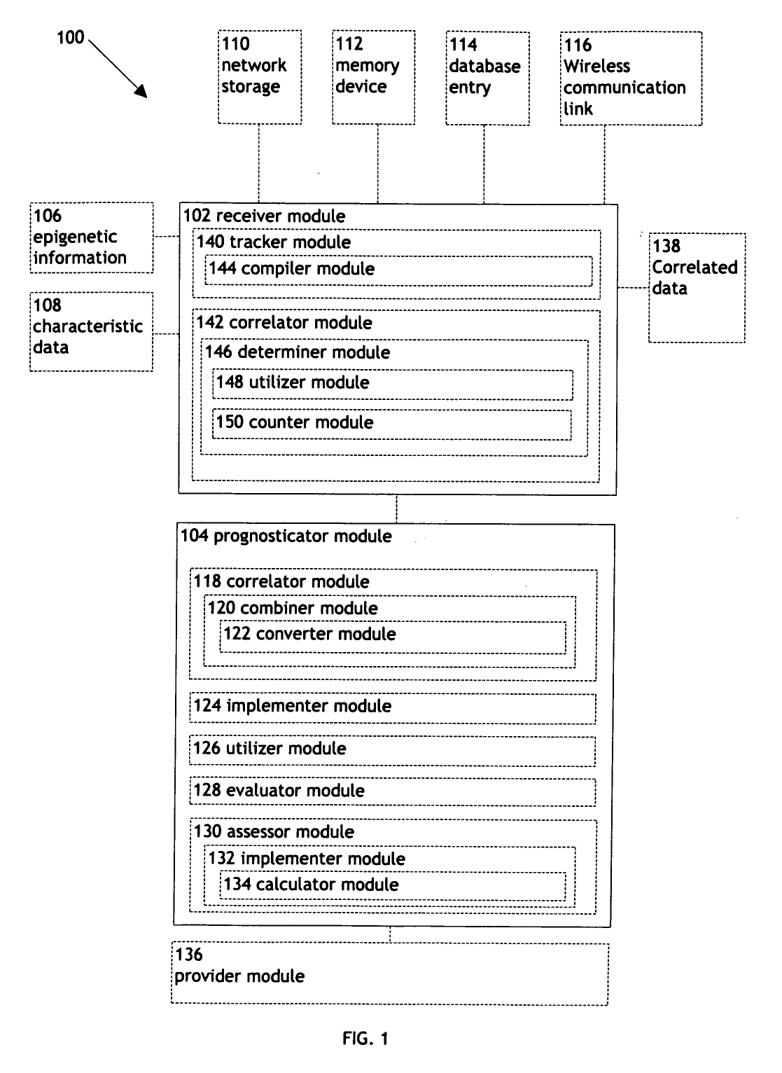

Referring to FIG. 1, a system 100 for receiving epigenetic information associated with at least a specific individual and/or prognosticating a risk at least partially based on the epigenetic information associated with at least a specific individual and the at least one correlation of epigenetic information associated with at least a first individual for at least a first epigenetic-information interval of time with disability data associated with at least a first individual for at least a first disability-data interval of time is illustrated. The system 100 may include receiver module 102, prognosticator module 104, and/or provider module 136. Receiver module 102 may receive epigenetic information 106, correlated data 138, and/or characteristic data 108 from network storage 110, memory device 112, database entry 114, and/or wireless communication link 116. Receiver module 102 may further include tracker module 140 and/or correlator module 142. Tracker module 140 may include compiler module 144. Correlator module 142 may include determiner module 146. Determiner module 146 may include utilizer module 148 and/or counter module 150. Prognosticator module 104 may include correlator module 118, implementer module 124, utilizer module 126, evaluator module 128, and/or assessor module 130. Correlator module 118 may include combiner module 120. Combiner module 120 may include converter module 122. Assessor module 130 may include implementer module 132. Implementer module 132 may include calculator module 134. System 100 generally represents instrumentality for receiving epigenetic information associated with at least a specific individual, receiving at least one correlation of epigenetic information associated with at least a first individual for at least a first epigenetic-information interval of time with disability data associated with at least a first individual for at least a first disability-data interval of time, and/or prognosticating a risk at least partially based on the epigenetic information associated with at least a specific individual and the at least one correlation of epigenetic information associated with at least a first individual for at least a first epigenetic-information interval of time with disability data associated with at least a first individual for at least a first disability-data interval of time. The steps of receiving epigenetic information associated with at least a specific individual, receiving at least one correlation of epigenetic information associated with at least a first individual for at least a first epigenetic-information interval of time with disability data associated with at least a first individual for at least a first disability-data interval of time, and/or prognosticating a risk at least partially based on the epigenetic information associated with at least a specific individual and the at least one correlation of epigenetic information associated with at least a first individual for at least a first epigenetic-information interval of time with disability data associated with at least a first individual for at least a first disability-data interval of time may be accomplished electronically, such as with a set of interconnected electrical components, an integrated circuit, and/or a computer processor.

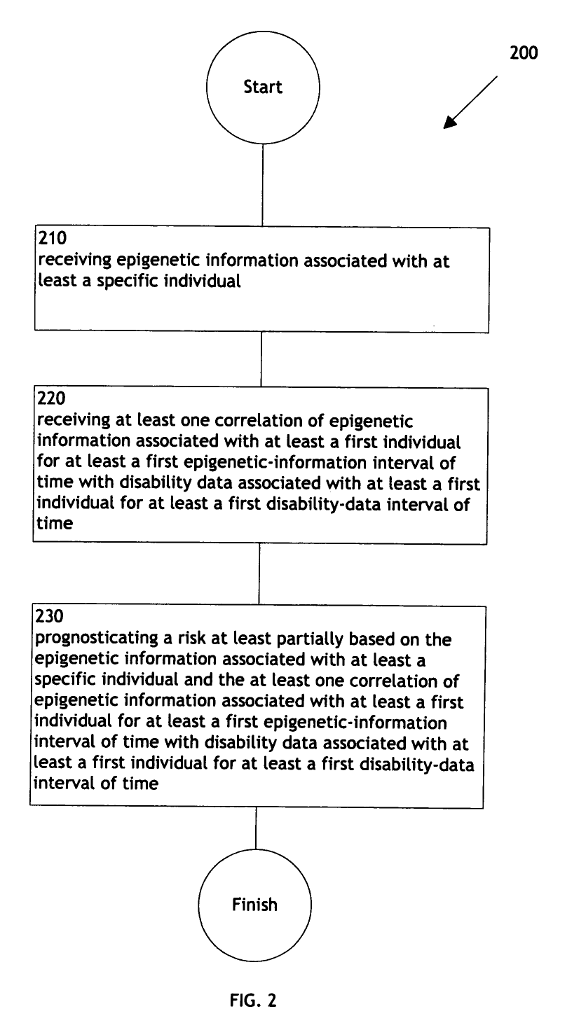

FIG. 2 illustrates an operational flow 200 representing example operations related to receiving epigenetic information associated with at least a specific individual, receiving at least one correlation of epigenetic information associated with at least a first individual for at least a first epigenetic-information interval of time with disability data associated with at least a first individual for at least a first disability-data interval of time, and/or prognosticating a risk at least partially based on the epigenetic information associated with at least a specific individual and the at least one correlation of epigenetic information associated with at least a first individual for at least a first epigenetic-information interval of time with disability data associated with at least a first individual for at Least a first disability-data interval of time. In FIG. 2 and in following figures that include various examples of operational flows, discussion and explanation may be provided with respect to the above-described examples of FIG. 1, and/or with respect to other examples and contexts. However, it should be understood that the operational flows may be executed in a number of other environments and contexts, and/or in modified versions of FIG. 1. Also, although the various operational flows are presented in the sequence(s) illustrated, it should be understood that the various operations may be performed in other orders than those which are illustrated, or may be performed concurrently.

After a start operation, the operational flow 200 moves to an operation 210. Operation 210 depicts receiving epigenetic information associated with at least a specific individual. For example, as shown in FIG. 1, receiver module 102 may receive epigenetic information 106 associated with at least a specific individual. A specific individual may include individual persons and/or single entities. Additionally, in some instances, the specific individual may have a familial and/or a blood relationship. In a specific example, receiver module 102 receives from network storage 110 epigenetic information 106 associated with a specific individual named John Smith. In some instances, receiver module 102 may include a computer processor. Some explanation regarding epigenetic information 106 may be found in sources such as Bird, Perceptions of Epigenetics, NATURE 477, 396-398 (2007); Grewat and Elgin, Transcription and RNA Interference in the Formation of Heterochromatin, NATURE 447: 399-406 (2007); and Callinan and Feinberg, The Emerging Science of Epigenomics, HUMAN MOLECULAR GENETICS 15, R95-R11 (2006), each of which are incorporated herein by reference. Epigenetic information may include, for example, information regarding DNA methylation, histone states or modifications, transcriptional activity, RNAi, protein binding or other molecular states. Further, epigenetic information may include information regarding inflammation-mediated cytosine damage products. See, e.g., VaLinluck and Sowers, Inflammation-Mediated Cytosine Damage: A Mechanistic Link Between Inflammation and the Epigenetic Alterations in Human Cancers, CANCER RESEARCH 67: 5583-5586 (2007), which is incorporated herein by reference. Any proper nouns and/or names used herein are meant to be exemplary only.

Then, operation 220 depicts receiving at least one correlation of epigenetic information associated with at least a first individual for at least a first epigenetic-information interval of time with disability data associated with at least a first individual for at least a first disability-data interval of time. For example, as shown in FIG. 1, receiver module 102 may receive at least one correlation of epigenetic information associated with at least a first individual for at least a first epigenetic-information interval of time with disability data associated with at least a first individual for at least a first disability-data interval of time. In one specific instance and continuing with the previous example, receiver module 102 receives a correlation of epigenetic information associated with a first group of five hundred individuals for a first epigenetic-information interval of time including a time period from 1990 to 2000 with disability data associated with the first group of five hundred individuals for at least a first disability-data interval of time including the time period from 1990 to 2000. In some instances, receiver module 102 may include a computer processor.

Then, operation 230 depicts prognosticating a risk at least partially based on the epigenetic information associated with at least a specific individual and the at least one correlation of epigenetic information associated with at least a first individual for at least a first epigenetic-information interval of time with disability data associated with at least a first individual for at least a first disability-data interval of time. For example, as shown in FIG. 1, prognosticator module 104 may prognosticate and/or predict a risk at Least partially based on the epigenetic information associated with at least a specific individual and the at least one correlation of epigenetic information associated with at least a first individual for at least a first epigenetic-information interval of time with disability data associated with at least a first individual for at least a first disability-data interval of time. In one specific instance and continuing with the previous example, prognosticator module 104 predicts a risk at least partially based on the epigenetic information associated with John Smith and the correlation of epigenetic information associated with a first group of five hundred individuals for at least a first epigenetic-information interval of time including the time period from 1990 to 2000 with disability data associated with the first group of five hundred individuals for at least a first disability-data interval of time including the time period from 1990 to 2000. In some instances, prognosticator module 104 may include a computer processor.

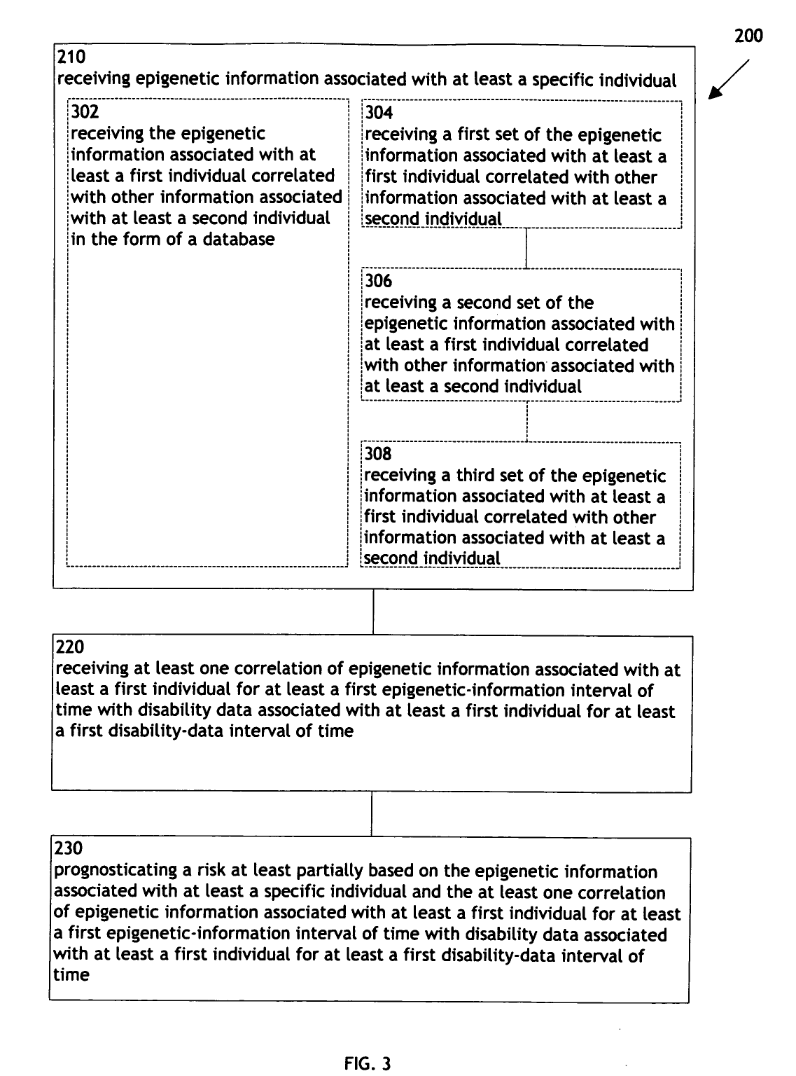

FIG. 3 illustrates alternative embodiments of the example operational flow 200 of FIG. 2. FIG. 3 illustrates example embodiments where the operation 210 may include at least one additional operation. Additional operations may include an operation 302, an operation 304, an operation 306, and/or an operation 308.

The operation 302 illustrates receiving the epigenetic information associated with at least a specific individual in the form of a database. For example, as shown in FIG. 1, receiver module 102 may receive the epigenetic information associated with at least a first individual correlated with other information associated with at least a second individual in the form of a database. In a specific instance, receiver module 102 receives from memory device 112 a database of epigenetic information associated with a group of ten individuals correlated with economic information associated with a group of five thousand individuals living in the same geographic location as the group of ten individuals. A database may include a collection of data organized for convenient access. The database may include information digitally stored in a memory device 112, as at least a portion of at least one database entry 114, in compact disc storage, and/or in network storage 110. In some instances, a database may include information stored non-digitally such as at least a portion of a book, a paper file, and/or a non-computerized index and/or catalog. Non-computerized information may be received by receiver module 102 by scanning or manually entering the information into a digital format. In some instances, receiver module 102 may include a computer processor.

The operation 304 illustrates receiving a first set of the epigenetic information associated with at least a specific individual. For example, as shown in FIG. 1, receiver module 102 may receive a first set of the epigenetic information associated with at least a first individual correlated with other information associated with at least a second individual. In a specific example, receiver module 102 receives from database entry 114 a first set of epigenetic information indicative of diabetes associated with a first individual named Eric Green correlated with dietary information associated with a group of ten thousand individuals residing in the same locality as Eric Green. Then, the operation 306 illustrates receiving a second set of the epigenetic information associated with at least a specific individual. For example, as shown in FIG. 1, receiver module 102 may receive a second set of the epigenetic information associated with at least a first individual correlated with other information associated with at least a second individual. In a specific example and continuing with the previous example, receiver module 102 receives from database entry 114 a second set of epigenetic information indicative of diabetes associated with a first individual named Eric Green correlated with dietary information associated with a group of ten thousand individuals residing in the same locality as Eric Green. Further, the operation 308 illustrates receiving a third set of the epigenetic information associated with at least a specific individual. For example, as shown in FIG. 1, receiver module 102 may receive a third set of the epigenetic information associated with at least a first individual correlated with other information associated with at least a second individual. In a specific example and continuing with the previous example, receiver module 102 receives from database entry 114 a third set of epigenetic information indicative of diabetes associated with a first individual named Eric Green correlated with dietary information associated with a group of ten thousand individuals residing in the same locality as Eric Green. In some instances, receiver module 102 may include a computer processor. In some instances, receiver module 102 may include a computer processor.

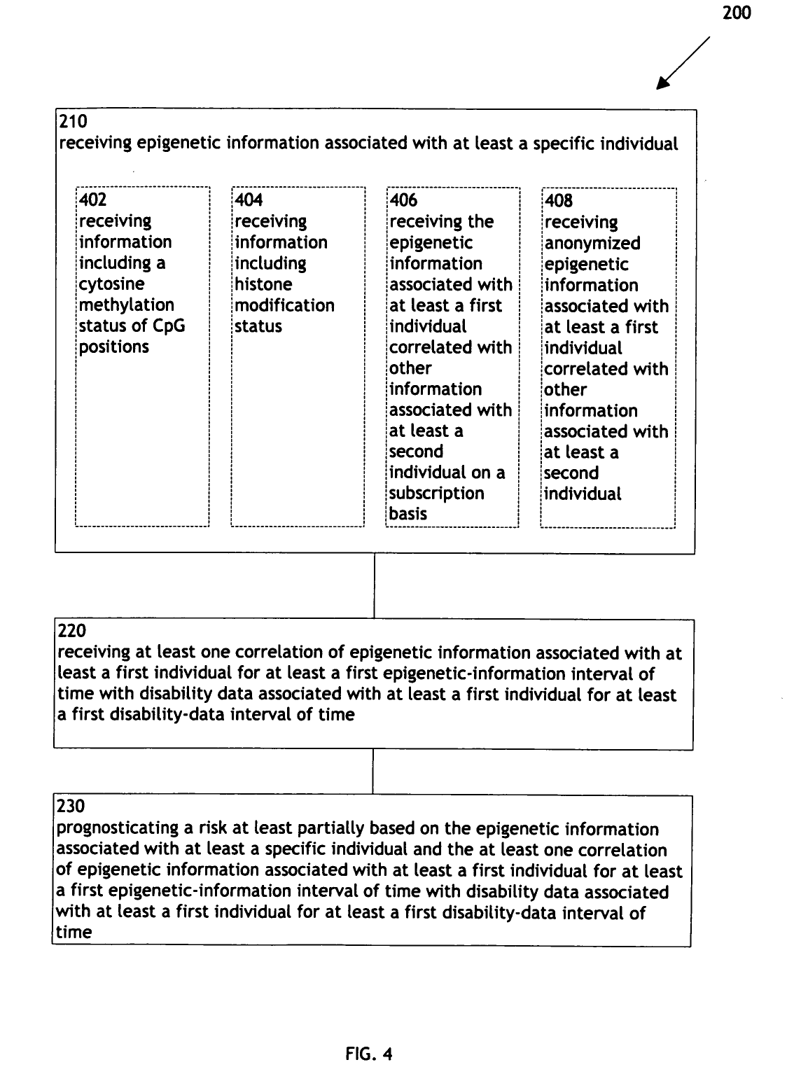

FIG. 4 illustrates alternative embodiments of the example operational flow 200 of FIG. 2. FIG. 4 illustrates example embodiments where the operation 210 may include at least one additional operation. Additional operations may include an operation 402, an operation 404, an operation 406, and/or an operation 408.

The operation 402 illustrates receiving information including a cytosine methylation status of CpG positions. For example, as shown in FIG. 1, receiver module 102 may receive information including a cytosine methylation status of CpG positions. In one instance, receiver module 102 receives from wireless communication link 116 information including a cytosine methylation status of CpG positions. DNA methylation and cytosine methylation status of CpG positions for an individual may include information regarding the methylation status of DNA generally or in the aggregate, or information regarding DNA methylation at one or more specific DNA loci, DNA regions, or DNA bases. See, for example: Shilatifard, Chromatin modifications by methylation and ubiquitination: implications in the regulation of gene expression, ANNUAL REVIEW OF BIOCHEMISTRY, 75:243-269 (2006); and Zhu and Yao, Use of DNA methylation for cancer detection and molecular classification, JOURNAL OF BIOCHEMISTRY AND MOLECULAR BIOLOGY, 40:135-141 (2007), each of which are incorporated herein by reference. In some instances, receiver module 102 may include a computer processor.

The operation 404 illustrates receiving information including histone modification status. For example, as shown in FIG. 1, receiver module 102 may receive information including histone modification status. In one instance, receiver module 102 receives from network storage 110 information including histone modification status. Information regarding histone structure may, for example, include information regarding specific subtypes or classes of histones, such as H1, H2A, H2B, H3 or H4. Information regarding histone structure may have an origin in array-based techniques, such as described in Barski et al., High-resolution profiling of histone methylations in the human genome, CELL 129, 823-837 (2007), which is incorporated herein by reference. In some instances, receiver module 102 may include a computer processor.

The operation 406 illustrates receiving the epigenetic information associated with at least a specific individual on a subscription basis. For example, as shown in FIG. 1, receiver module 102 may receive the epigenetic information associated with at least a first individual correlated with other information associated with at least a second individual on a subscription basis. In one instance, receiver module 102 receives from database entry 114 epigenetic information associated with a first individual named Robert Smith correlated with information including career information associated with a group of individuals in the same career field as Robert Smith on a monthly subscription basis. A subscription may include an agreement to receive and/or be given access to the epigenetic information. The subscription may include access to epigenetic information in a digital form and/or a physical form of information, such as paper printouts. In some instances, receiver module 102 may include a computer processor.

The operation 408 illustrates receiving anonymized epigenetic information associated with at least a specific individual. For example, as shown in FIG. 1, receiver module 102 may receive anonymized epigenetic information associated with at least a first individual correlated with other information associated with at least a second individual. In one example, receiver module 102 receives from memory device 112 anonymized epigenetic information associated with an individual named Fred Hansen correlated with other information including economic data associated with a group of one hundred individuals Living in the same city as Fred Hansen. Anonymized epigenetic information may be received for more than one individual, such as a group of two hundred individuals. Additionally, anonymized epigenetic information may be anonymized in different degrees and/or by different methods. Different degrees of anonymization may include full anonymization and/or partial anonymization, such as in the case of pseudonym utilization. Methods for anonymizing epigenetic information may include the use of cell suppression and/or utilizing anonymization algorithms. In some instances, receiver module 102 may include a computer processor.

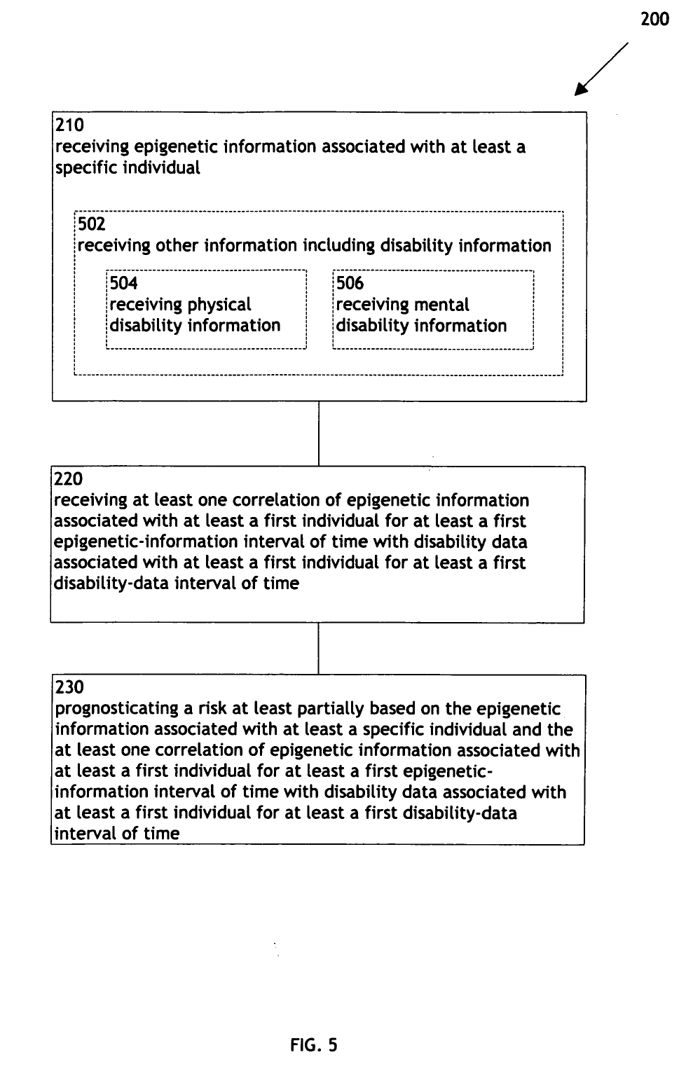

FIG. 5 illustrates alternative embodiments of the example operational flow 200 of FIG. 2. FIG. 5 illustrates example embodiments where the operation 210 may include at least one additional operation. Additional operations may include an operation 502, an operation 504, and/or an operation 506.

The operation 502 illustrates receiving other information including disability information. For example, as shown in FIG. 1, receiver module 102 may receive other information including disability information. In a specific example, receiver module 102 receives from database entry 114 other information including disability information. Disability information may include information including disease information, mental disability, physical disability, emotional disability, and/or other incapacities that may curtail a person's ability. Further, the operation 504 illustrates receiving physical disability information. For example, as shown in FIG. 1, receiver module 102 may receive physical disability information. In one specific instance, receiver module 102 receives from network storage 110 physical disability information including an occurrence of paralysis. A physical disability may include physical impairment, sensory impairment, chronic disease, as well as other impairment to body structure and/or impairment to body function. In some instances, receiver module 102 may include a computer processor. Further, the operation 506 illustrates receiving mental disability information. For example, as shown in FIG. 1, receiver module 102 may receive mental disability information. In one instance, receiver module 102 receives from wireless communication link 116 mental disability information including an occurrence of a learning disability for an inner city school district. A mental disability may include a mental impairment that limits one or more major life activities of the person with the mental impairment. Examples of a mental disability and/or a mental impairment may include depression, mania, bipolar disorder, mental retardation, learning difficulty, mood disorders, anxiety disorders, psychotic disorders, eating disorders, personality disorders, as well as many other disabilites. In some instances, receiver module 102 may include a computer processor.

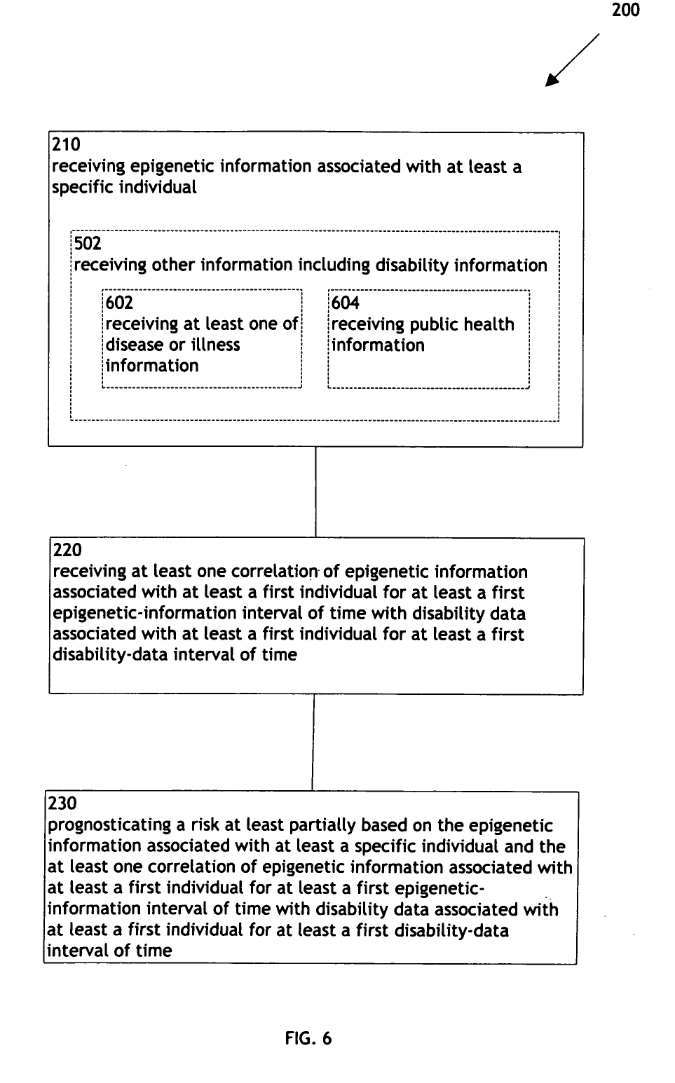

FIG. 6 illustrates alternative embodiments of the example operational flow 200 of FIG. 2. FIG. 6 illustrates example embodiments where the operation 210 may include at least one additional operation. Additional operations may include an operation 602, and/or an operation 604. Further, the operation 602 illustrates receiving at least one of disease or illness information. For example, as shown in FIG. 1, receiver module 102 may receive at least one of disease or illness information. In one example, receiver module 102 receives disease and illness information from database entry 114. Disease information may include information regarding the occurrence of disease, disease rates, occurrences of cured disease, and/or other information pertaining to disease. Illness information may include information relating to the rate of occurrence and/or nonoccurrence of an illness, predisposition to an illness, and/or other information regarding an illness. In some instances, receiver module 102 may include a computer processor. Further, the operation 604 illustrates receiving public health information. For example, as shown in FIG. 1, receiver module 102 may receive public health information. In one instance, receiver module 102 receives public health information from network storage 110. Public health information may include information obtained from an international agency, a national agency, a state agency, a local agency, and/or other sources of health information. Examples of agencies that may supply public health information may include the World Health Organization (WHO), the World Bank, the United Nations, the Pan American Health Organization (PAHO), the United Nations Children's Fund (UNICEF), the United Nation Development Programme (UNDP), Oxfam, Project Hope, the Centers for Disease Control and Prevention (CDC), the United States Department for Health and Human Services (HHS), the Office of Public Health and Science, the Office of the Surgeon General, the United States Department for Veterans Affairs, The New York City Department of Health and Mental Hygiene, and/or the California Department of Health Services. In some instances, receiver module 102 may include a computer processor.

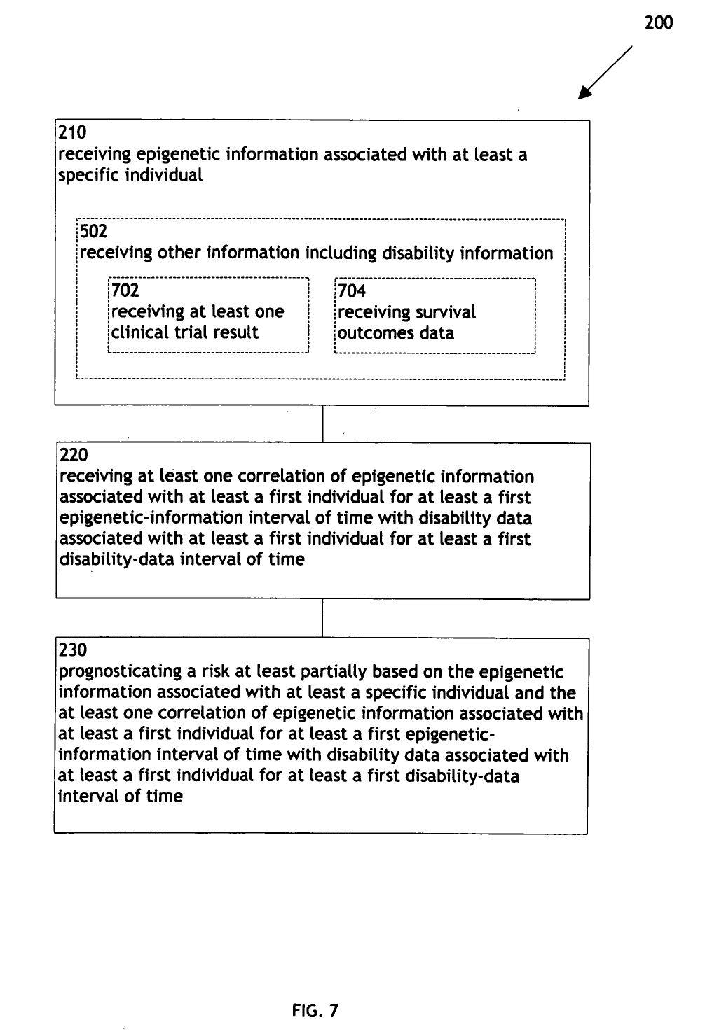

FIG. 7 illustrates alternative embodiments of the example operational flow 200 of FIG. 2. FIG. 7 illustrates example embodiments where the operation 210 may include at least one additional operation. Additional operations may include an operation 702, and/or an operation 704. Further, the operation 702 illustrates receiving at least one clinical trial result. For example, as shown in FIG. 1, receiver module 102 may receive from memory device 112 at least one clinical trial result. In a specific instance, receiver module 102 receives a batch of clinical trial results. A clinical trial result may include a result from a series of research studies using a limited number of patients. In some instances, receiver module 102 may include a computer processor. Further, the operation 704 illustrates receiving survival outcomes data. For example, as shown in FIG. 1, receiver module 102 may receive survival outcomes data. In a specific example, receiver module 102 receives survival outcomes data. Survival outcomes data may include data showing the amount of people with a certain disease who survive for a specific amount of time. The data may measure time for diagnosis and/or from receiving a specific treatment. Survival outcomes data may include results from other responses to treatment, such as quality of life and/or side effects. In some instances, receiver module 102 may include a computer processor.

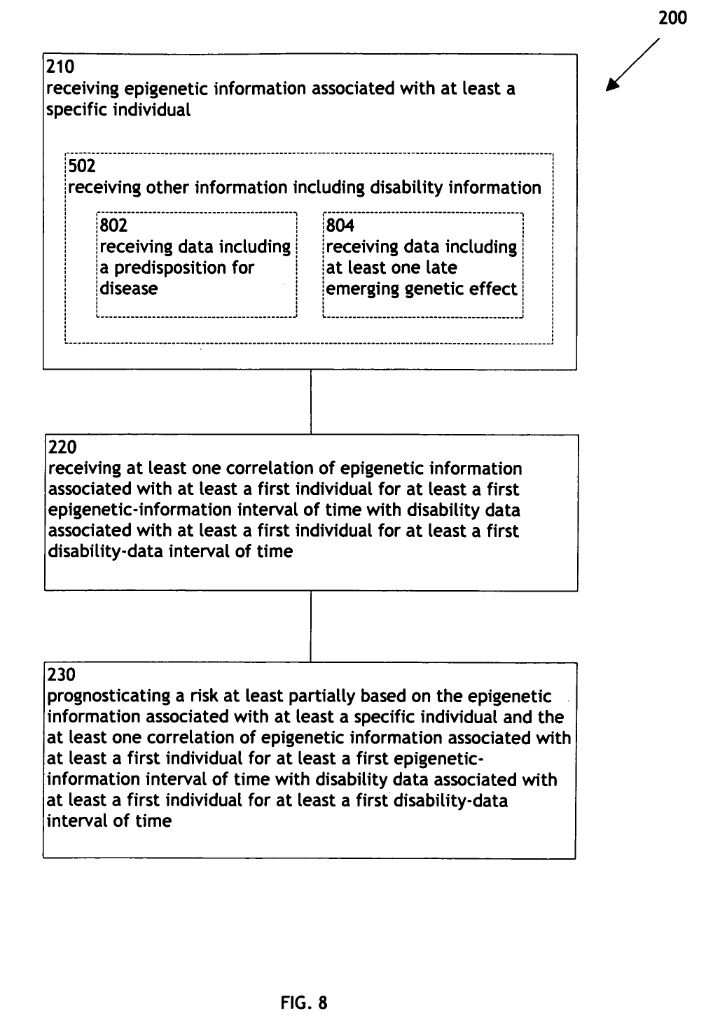

FIG. 8 illustrates alternative embodiments of the example operational flow 200 of FIG. 2. FIG. 8 illustrates example embodiments where the operation 210 may include at least one additional operation. Additional operations may include an operation 802, and/or an operation 804. Further, the operation 802 illustrates receiving data including a predisposition for disease. For example, as shown in FIG. 1, receiver module 102 may receive data including a predisposition for disease. In one example, receiver module 102 receives from wireless communication link 116 data including a predisposition for disease for a population of retirees living in Florida. A predisposition for disease may include a tendency to a condition or quality and may be based on the combined effects of epigenetics, genetics, and/or other environmental factors. Further, the operation 804 illustrates receiving data including at least one late emerging genetic effect. For example, as shown in FIG. 1, receiver module 102 may receive data including at least one late emerging genetic effect. In a specific example, receiver module 102 receives from network storage 110 data including a late emerging genetic effect including a disposition for Parkinson's disease. A late emerging effect may include effects, occurring after a certain period of time not having the effect, resulting from genetic, epigenetic, environmental, and/or other factors. The effects may include disease, illness, side reactions, physical disability, emotional disability, mental disability, and/or other types of impairment. In some instances, receiver module 102 may include a computer processor.

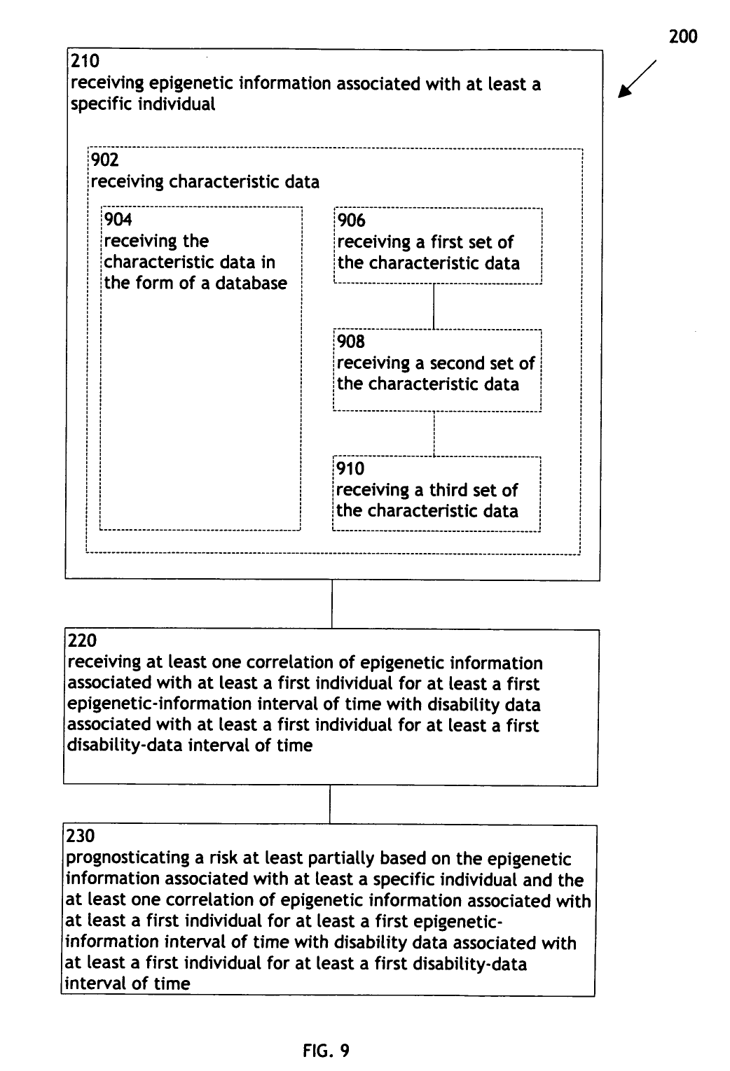

FIG. 9 illustrates alternative embodiments of the example operational flow 200 of FIG. 2. FIG. 9 illustrates example embodiments where the operation 210 may include at least one additional operation. Additional operations may include an operation 902, an operation 904, an operation 906, an operation 908, and/or an operation 910.

The operation 902 illustrates receiving characteristic data. For example, as shown in FIG. 1, receiver module 102 may receive characteristic data 108. In a specific instance, receiver module 102 receives characteristic data 108 from database entry 114 including a personal health history. Characteristic data 108 may include environmental data, financial data, habit data, consumption data, dietary data, and/or other data related to personal and/or population characteristics. In some instances, receiver module 102 may include a computer processor. Further, the operation 904 illustrates receiving the characteristic data in the form of a database. For example, as shown in FIG. 1, receiver module 102 may receive the characteristic data 108 in the form of a database. In one instance, receiver module 102 receives characteristic data 108 from database entry 114 in the form of a database. A database may include a collection of data organized for convenient access. The database may include information digitally stored in a memory device 112, as at least a portion of at least one database entry 114, in compact disc storage, and/or in network storage 110. In some instances, a database may include information stored non-digitally such as at least a portion of a book, a paper file, and/or a non-computerized index and/or catalog. Non-computerized information may be received by receiver module 102 by scanning or manually entering the information into a digital format. In some instances, receiver module 102 may include a computer processor. Further, the operation 906 illustrates receiving a first set of the characteristic data. For example, as shown in FIG. 1, receiver module 102 may receive a first set of the characteristic data 108. In one example, receiver module 102 receives from database entry 114 a first set of characteristic data 108 including dietary information. In some instances, receiver module 102 may include a computer processor. Then, the operation 908 illustrates receiving a second set of the characteristic data. For example, as shown in FIG. 1, receiver module 102 may receive a second set of the characteristic data 108. In a specific example continuing with the previous example, receiver module 102 receives from database entry 114 a second set of characteristic data 108 including dietary information. In some instances, receiver module 102 may include a computer processor. Further, the operation 910 illustrates receiving a third set of the characteristic data. For example, as shown in FIG. 1, receiver module 102 may receive a third set of the characteristic data 108. In one instance continuing with the previous example, receiver module 102 receives from database entry 114 a third set of characteristic data 108 including dietary information. In some instances, receiver module 102 may include a computer processor. Additional sets of information may be received by receiver module 102 as batches and/or finite sets beyond the first, second, and/or third set of epigenetic information.

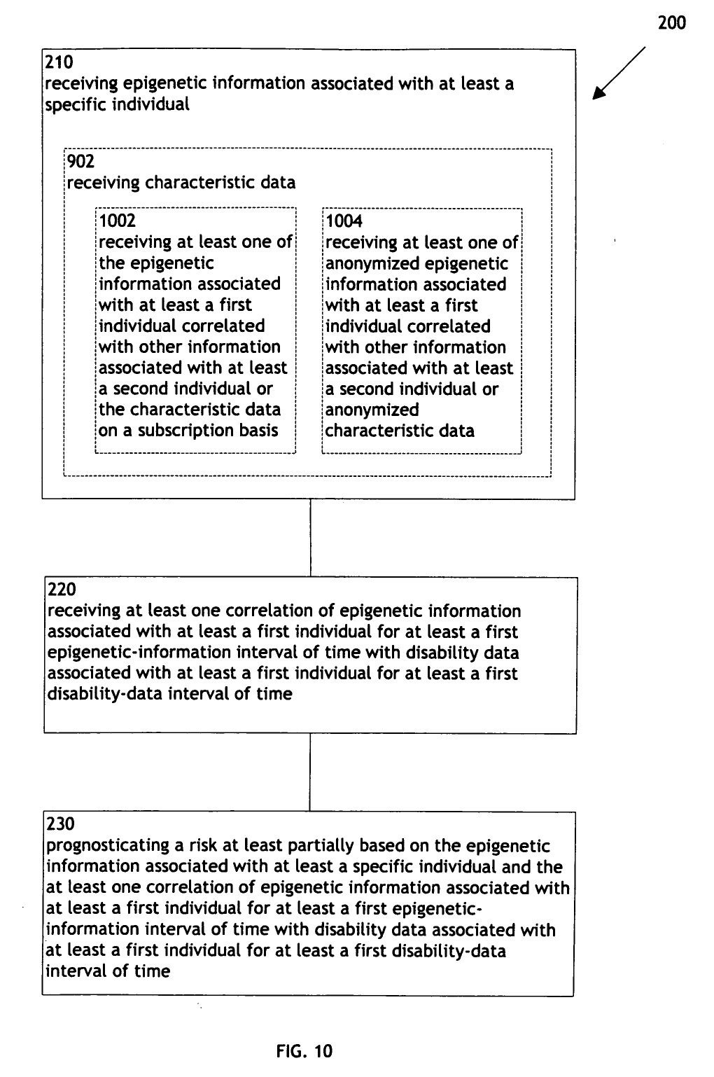

FIG. 10 illustrates alternative embodiments of the example operational flow 200 of FIG. 2. FIG. 10 illustrates example embodiments where the operation 210 may include at least one additional operation. Additional operations may include an operation 1002, and/or an operation 1004. Further, the operation 1002 illustrates receiving at least one of the epigenetic information associated with at least a specific individual or the characteristic data on a subscription basis. For example, as shown in FIG. 1, receiver module 102 may receive at least one of the epigenetic information associated with at least a first individual correlated with other information associated with at least a second individual or the characteristic data 108 on a subscription basis. In one specific instance, receiver module 102 receives characteristic data 108 from wireless communication link 116 on a subscription basis. A subscription may include an agreement to receive and/or be given access to the epigenetic information. The subscription may include access to epigenetic information in a digital form and/or a physical form of information, such as paper printouts. In some instances, receiver module 102 may include a computer processor. Further, the operation 1004 illustrates receiving at least one of anonymized epigenetic information associated with at least a specific individual or anonymized characteristic data. For example, as shown in FIG. 1, receiver module 102 may receive at least one of anonymized epigenetic information associated with at least a first individual correlated with other information associated with at least a second individual or anonymized characteristic data 108. In one instance, receiver module 102 receives from memory device 112 anonymized epigenetic information associated with an individual named Roger Black correlated with other information including health information associated with a group of one thousand individuals residing in the same retirement community as Roger Black. In some instances, receiver module 102 may include a computer processor.

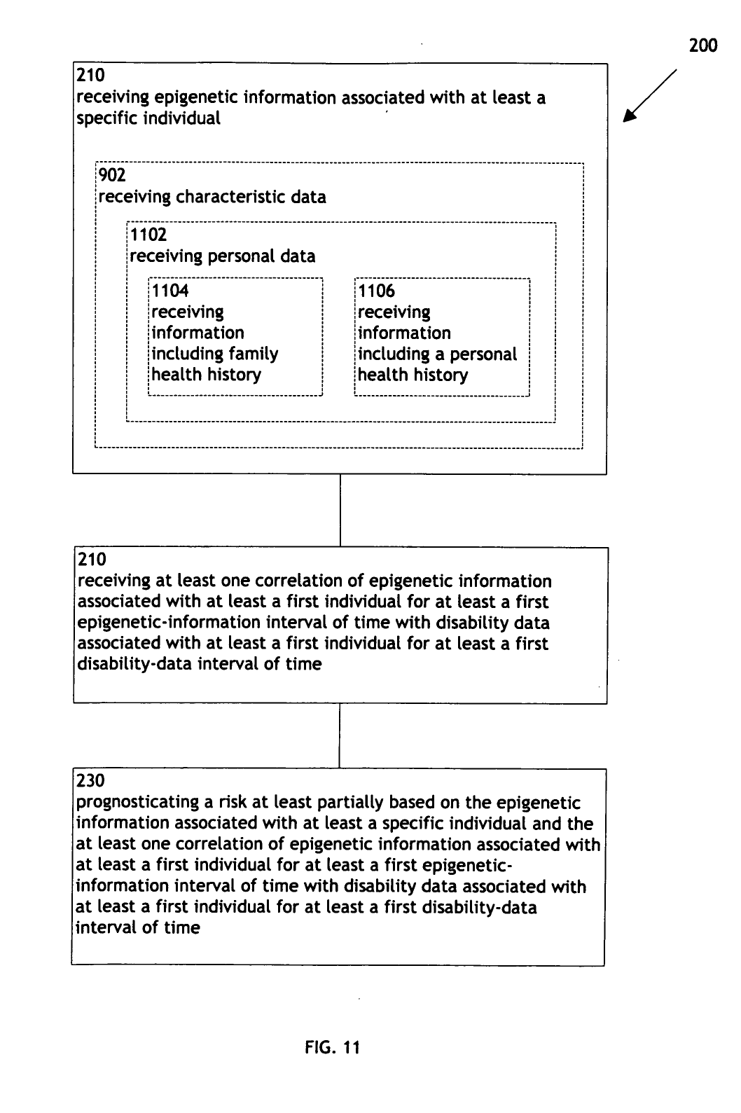

FIG. 11 illustrates alternative embodiments of the example operational flow 200 of FIG. 2. FIG. 11 illustrates example embodiments where the operation 210 may include at least one additional operation. Additional operations may include an operation 1102, an operation 1104, and/or an operation 1106. Further, the operation 1102 illustrates receiving personal data. For example, as shown in FIG. 1, receiver module 102 may receive personal data. In one instance, receiver module 102 receives from database entry 114 personal data including a personal health history. Personal data may include any data relating to a person and/or the person's habits, lifestyle, and/or environment. In some instances, receiver module 102 may include a computer processor. Further, the operation 1104 illustrates receiving information including family health history. For example, as shown in FIG. 1, receiver module 102 may receive information including family health history. In one instance, receiver module 102 receives information including family health history for a group of five hundred individuals from network storage 110. A family health history may include occurrences relating to the health of a certain family, including the occurrences of an illness and/or disease, a genetic predisposition to a certain disease, and/or other genetic traits. In some instances, receiver module 102 may include a computer processor. Further, the operation 1106 illustrates receiving information including a personal health history. For example, as shown in FIG. 1, receiver module 102 may receive information including a personal health history. In a specific example, receiver module 102 receives information from network storage 110 including a personal health history for an individual named Shirley Johnson. A personal health history may include past diseases and/or illnesses, medication regiments and/or treatment regiments, and/or past health provider visits as well as other occurrences relating to an individual's health. In some instances, receiver module 102 may include a computer processor.

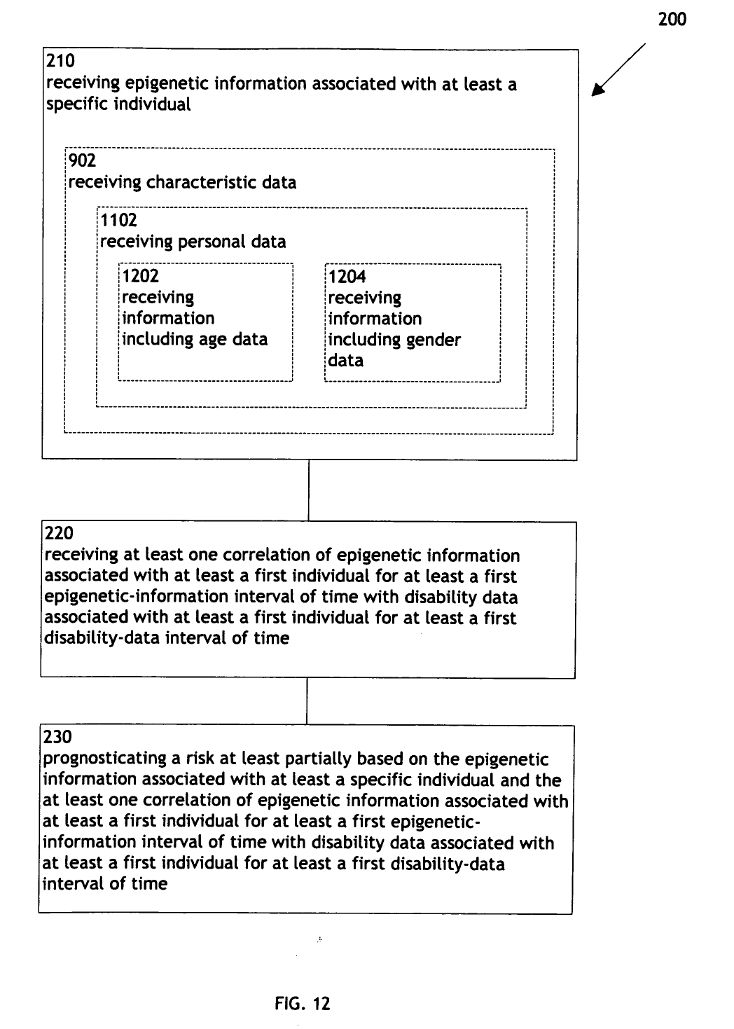

FIG. 12 illustrates alternative embodiments of the example operational flow 200 of FIG. 2. FIG. 12 illustrates example embodiments where the operation 210 may include at least one additional operation. Additional operations may include an operation 1202, and/or an operation 1204. Further, the operation 1202 illustrates receiving information including age data. For example, as shown in FIG. 1, receiver module 102 may receive information including age data. In one instance, receiver module 102 receives information from memory device 112 including age data for the state of Arizona. Age data may include the number of people over the age of majority, the number of people collecting retirement benefits, the number of retirement communities in a geographic location, and/or the number of minors in a geographic location. In some instances, receiver module 102 may include a computer processor. Further, the operation 1204 illustrates receiving information including gender data. For example, as shown in FIG. 1, receiver module 102 may receive information including gender data. In one instance, receiver module 102 receives information from memory device 112 including gender data for the city of San Francisco, Calif. Gender data may include information regarding gender distribution and/or gender percentage for a certain population. In some instances, receiver module 102 may include a computer processor.

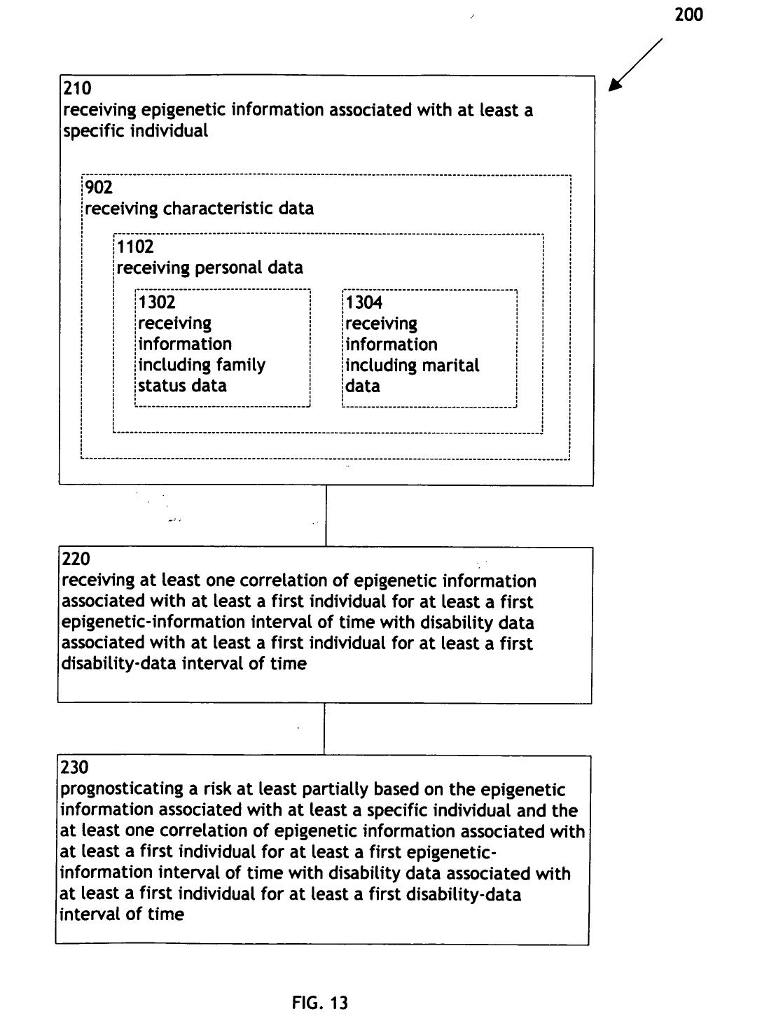

FIG. 13 illustrates alternative embodiments of the example operational flow 200 of FIG. 2. FIG. 13 illustrates example embodiments where the operation 210 may include at least one additional operation. Additional operations may include an operation 1302, and/or an operation 1304. Further, the operation 1302 illustrates receiving information including family status data. For example, as shown in FIG. 1, receiver module 102 may receive information including family status data. In one example, receiver module 102 receives information from memory device 112 including family status data. Family status may include divorce information, the number of children in a family and/or household, the occurrence of disease and/or illness in a family, and/or the number of biological children a couple may have. In some instances, receiver module 102 may include a computer processor. Further, the operation 1304 illustrates receiving information including marital data. For example, as shown in FIG. 1, receiver module 102 may receive information including marital data. In one example, receiver module 102 receives marital data from database entry 114 including the number of divorces for a certain geographic location. Marital data may include the number of marriages for a certain population and/or the number of divorces for a certain population. In some instances, receiver module 102 may include a computer processor.

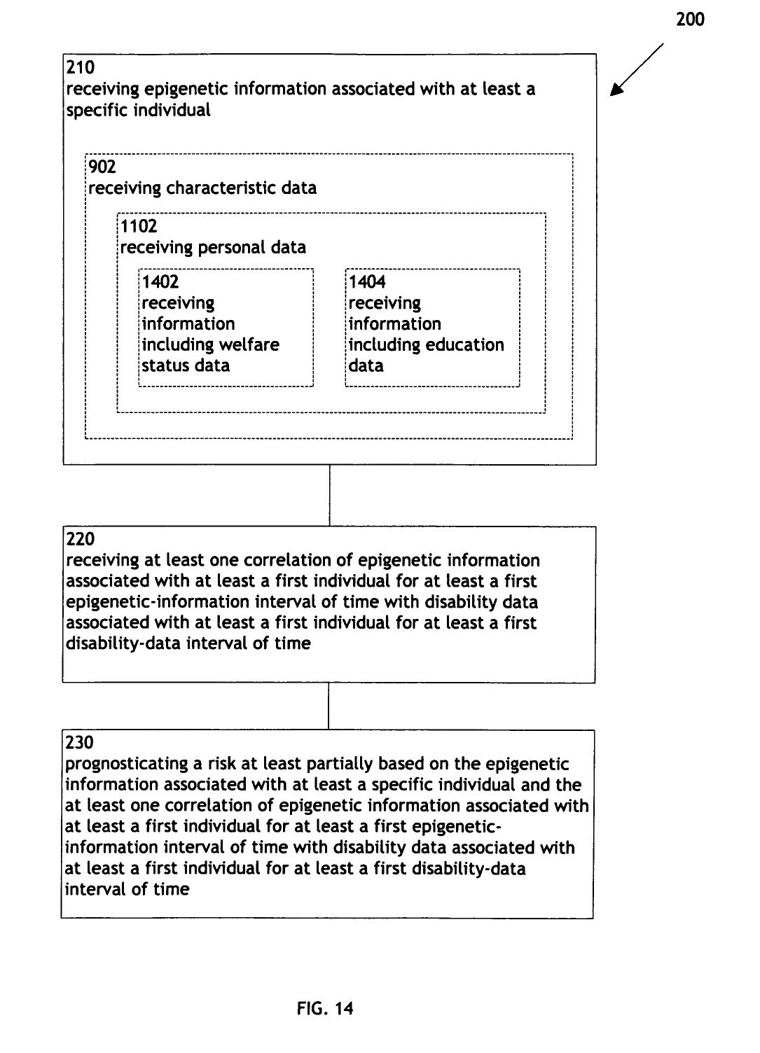

FIG. 14 illustrates alternative embodiments of the example operational flow 200 of FIG. 2. FIG. 14 illustrates example embodiments where the operation 210 may include at least one additional operation. Additional operations may include an operation 1402, and/or an operation 1404. Further, the operation 1402 illustrates receiving information including welfare status data. For example, as shown in FIG. 1, receiver module 102 may receive information including welfare status data. In one specific example, receiver module 102 receives information from database entry 114 including welfare status data. Welfare status data may include a number of welfare recipients for a certain population, the amount of welfare benefits a certain population receives, unemployment insurance benefits for a certain population, and/or the amount of disability benefits received by a certain population. In some instances, receiver module 102 may include a computer processor. Further, the operation 1404 illustrates receiving information including education data. For example, as shown in FIG. 1, receiver module 102 may receive information including education data. In one example, receiver module 102 receives information from wireless communication link 116 including education data. Educational data may include the level of education attained for a certain population, the number of a specific degree obtained by a certain population, and/or the number of students for a certain population and/or geographic location. In some instances, receiver module 102 may include a computer processor.

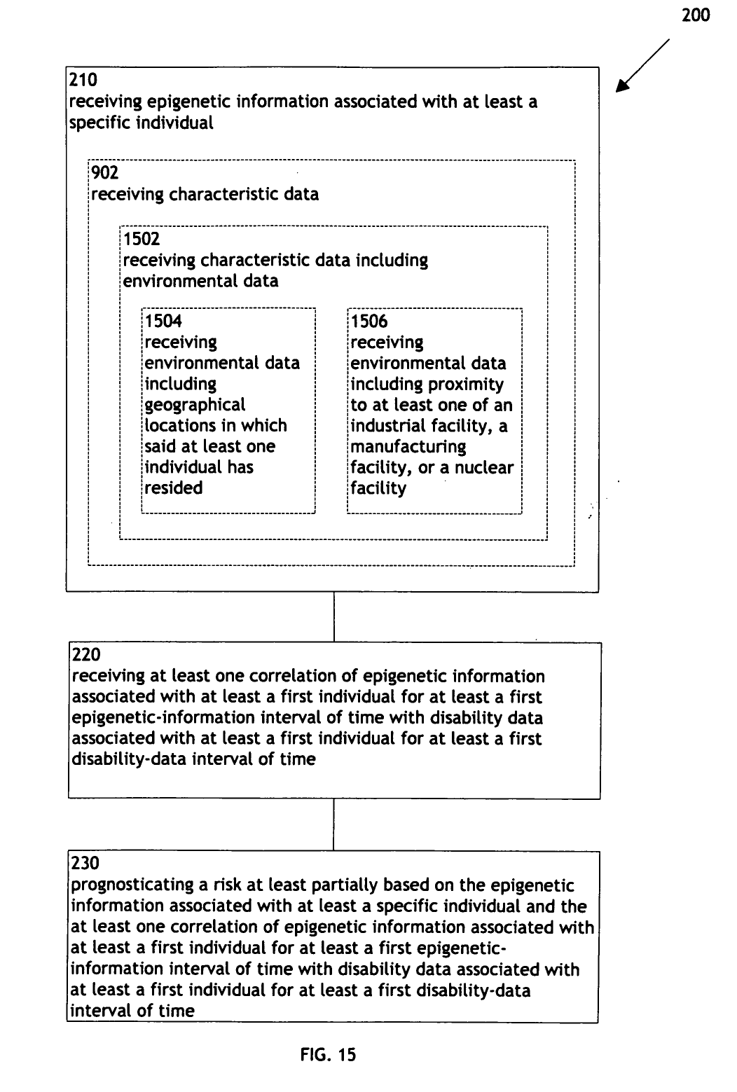

FIG. 15 illustrates alternative embodiments of the example operational flow 200 of FIG. 2. FIG. 15 illustrates example embodiments where the operation 210 may include at least one additional operation. Additional operations may include an operation 1502, an operation 1504, and/or an operation 1506. Further, the operation 1502 illustrates receiving characteristic data including environmental data. For example, as shown in FIG. 1, receiver module 102 may receive characteristic data 108 including environmental data. In one example, receiver module 102 receives characteristic data 108 including environmental data from memory device 112. Environmental data may include weather data and/or other data regarding the surroundings of a certain person and/or population. In some instances, receiver module 102 may include a computer processor. Further, the operation 1504 illustrates receiving environmental data including geographical locations in which said at least one individual has resided. For example, as shown in FIG. 1, receiver module 102 may receiving environmental data including geographical locations in which said at least one individual has resided. In one instance, receiver module 102 receives from database entry 114 environmental data including geographical locations in which an individual named Frank Anderson has resided. Geographical locations may include neighborhoods, cities, states, and/or countries. In some instances, receiver module 102 may include a computer processor. Further, the operation 1506 illustrates receiving environmental data including proximity to at least one of an industrial facility, a manufacturing facility, or a nuclear facility. For example, as shown in FIG. 1, receiver module 102 may receive environmental data including proximity to at least one of an industrial facility, a manufacturing facility, or a nuclear facility. In one instance, receiver module 102 receives environmental data from network storage 110 including the proximity a group of insurance applicants reside to an industrial facility. An industrial facility may include a facility associated with the industrial production of goods and/or industrial waste, distribution of goods, mining, and/or other organizations engaged in a process of creating and/or changing a raw material into another form and/or product. A manufacturing facility may include a facility for producing goods and/or services. A nuclear facility may include a facility engaged in nuclear research, nuclear reaction, and/or the handling and/or storage of waste. In some instances, receiver module 102 may include a computer processor.

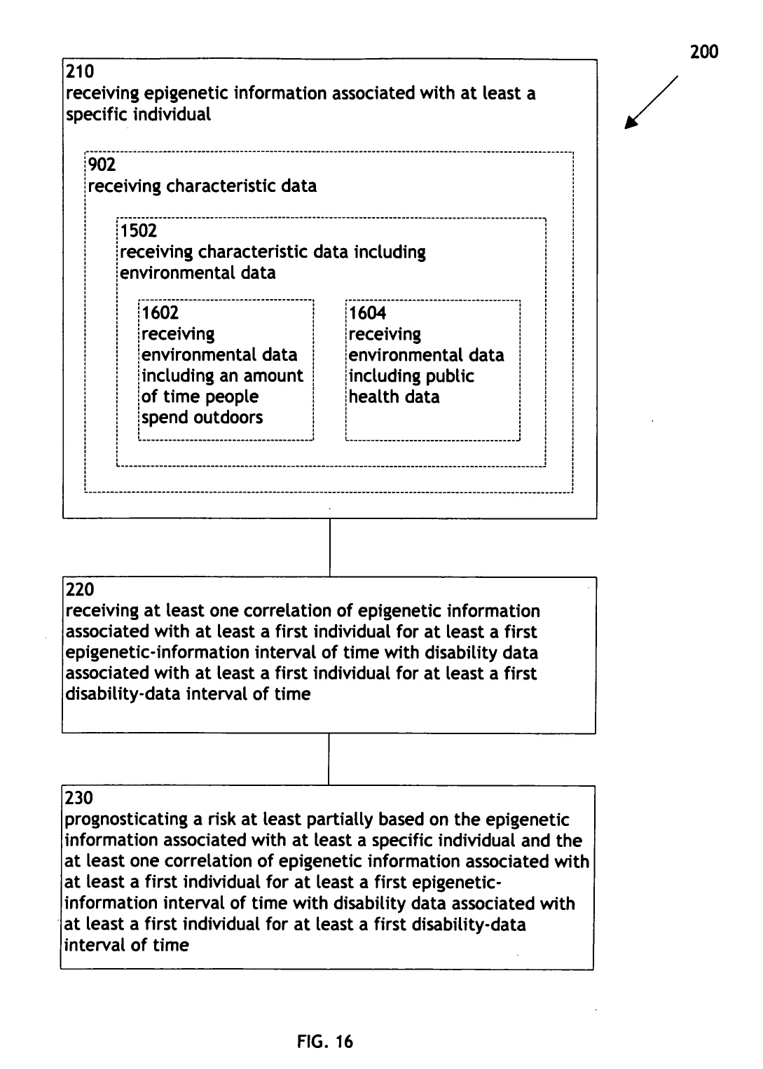

FIG. 16 illustrates alternative embodiments of the example operational flow 200 of FIG. 2. FIG. 16 illustrates example embodiments where the operation 210 may include at least one additional operation. Additional operations may include an operation 1602, and/or an operation 1604. Further, the operation 1602 illustrates receiving environmental data including an amount of time people spend outdoors. For example, as shown in FIG. 1, receiver module 102 may receive environmental data including an amount of time people spend outdoors. In one example, receiver module 102 receives environmental data from network storage 110 including an amount of time spent outdoors by people living in a certain location. Time spent outdoors may include time recreating and/or time spent while exposed to sunlight. In some instances, receiver module 102 may include a computer processor. Further, the operation 1604 illustrates receiving environmental data including public health data. For example, as shown in FIG. 1, receiver module 102 may receive environmental data including public health data. In one instance, receiver module 102 receives environmental data from network storage 110 including public health data. Public health data may include information associated with the health of a population of people and may be obtained from a health agency and/or an academic institution. In some instances, receiver module 102 may include a computer processor.

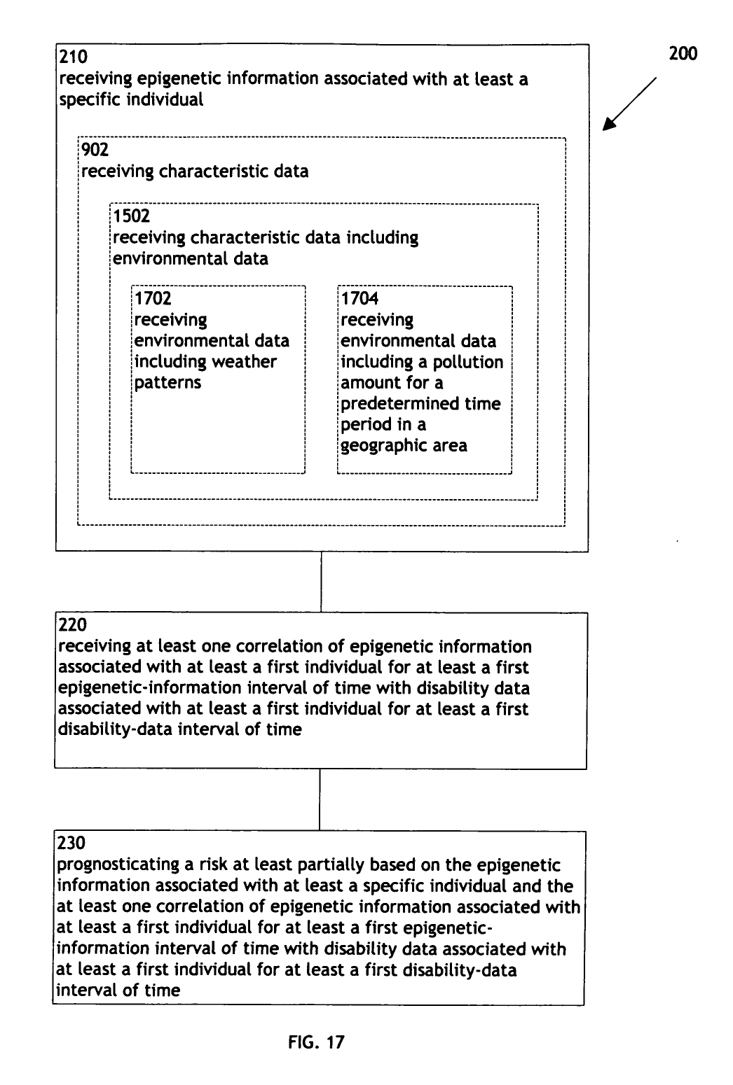

FIG. 17 illustrates alternative embodiments of the example operational flow 200 of FIG. 2. FIG. 17 illustrates example embodiments where the operation 210 may include at least one additional operation. Additional operations may include an operation 1702, and/or an operation 1704. Further, the operation 1702 illustrates receiving environmental data including a weather pattern. For example, as shown in FIG. 1, receiver module 102 may receive environmental data including weather patterns. In one instance, receiver module 102 receives environmental data including weather patterns from wireless communication link 116. A weather pattern may include trends and/or repeats of atmospheric conditions, climate, temperatures, precipitation, storms, and/or movement of air. In some instances, receiver module 102 may include a computer processor. Further, the operation 1704 illustrates receiving environmental data including a pollution amount for a predetermined time period in a geographic area. For example, as shown in FIG. 1, receiver module 102 may receive environmental data including a pollution amount for a predetermined time period in a geographic area. In one example, receiver module 102 receives environmental data from wireless communication link 116 including a pollution amount in the form of an air quality index measurement for the city of Los Angeles, Calif. for the year 2000. A pollution amount may include a pollution index. A pollution index may include a measurement of pollution in a geographic location. Examples of a pollution index may include an air pollution index, an air quality index, and/or a pollutants standard index. In some instances, receiver module 102 may include a computer processor.

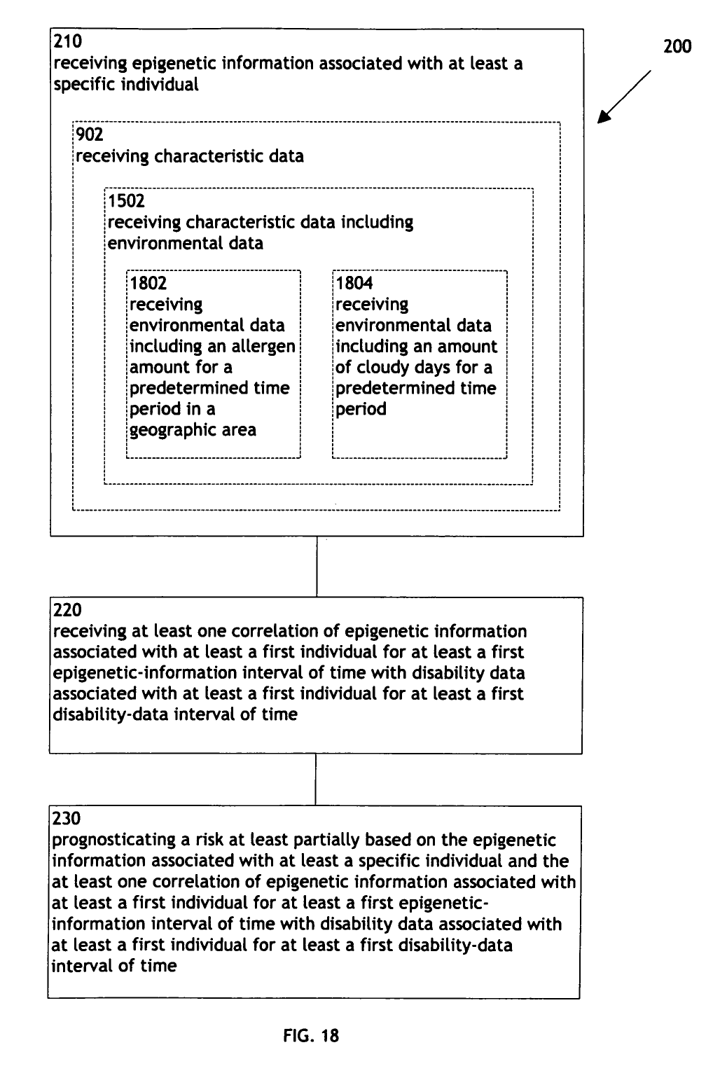

FIG. 18 illustrates alternative embodiments of the example operational flow 200 of FIG. 2. FIG. 18 illustrates example embodiments where the operation 210 may include at least one additional operation. Additional operations may include an operation 1802, and/or an operation 1804. Further, the operation 1802 illustrates receiving environmental data including an allergen amount for a predetermined time period in a geographic area. For example, as shown in FIG. 1, receiver module 102 may receive environmental data including an allergen amount for a predetermined time period in a geographic area. In one instance, receiver module 102 receives environmental data from wireless communication link 116 including an allergen amount for the year 2001 in New York City, N.Y. An allergen amount may be measured by an allergen index or may be compiled, such as in a database documenting the occurrences of at least one allergen and/or the effects of an allergen on a certain person and/or population. An allergen index may include a measurement of allergen amounts for a geographic location and/or area. Examples of allergens may include pollen, pet dander, dust, insect stings, mold, and/or spores. In some instances, receiver module 102 may include a computer processor. Further, the operation 1804 illustrates receiving environmental data including an amount of cloudy days for a predetermined time period. For example, as shown in FIG. 1, receiver module 102 may receive environmental data including an amount of cloudy days for a predetermined time period. In one example, receiver module 102 receives environmental data from network storage 110 including an amount of cloudy days for the months of December, January, and February for Minnesota. An amount of cloudy days for a predetermined time period may include days having different degrees and/or designations of cloud cover, such as partly sunny, partly cloudy, etc. In some instances, receiver module 102 may include a computer processor.

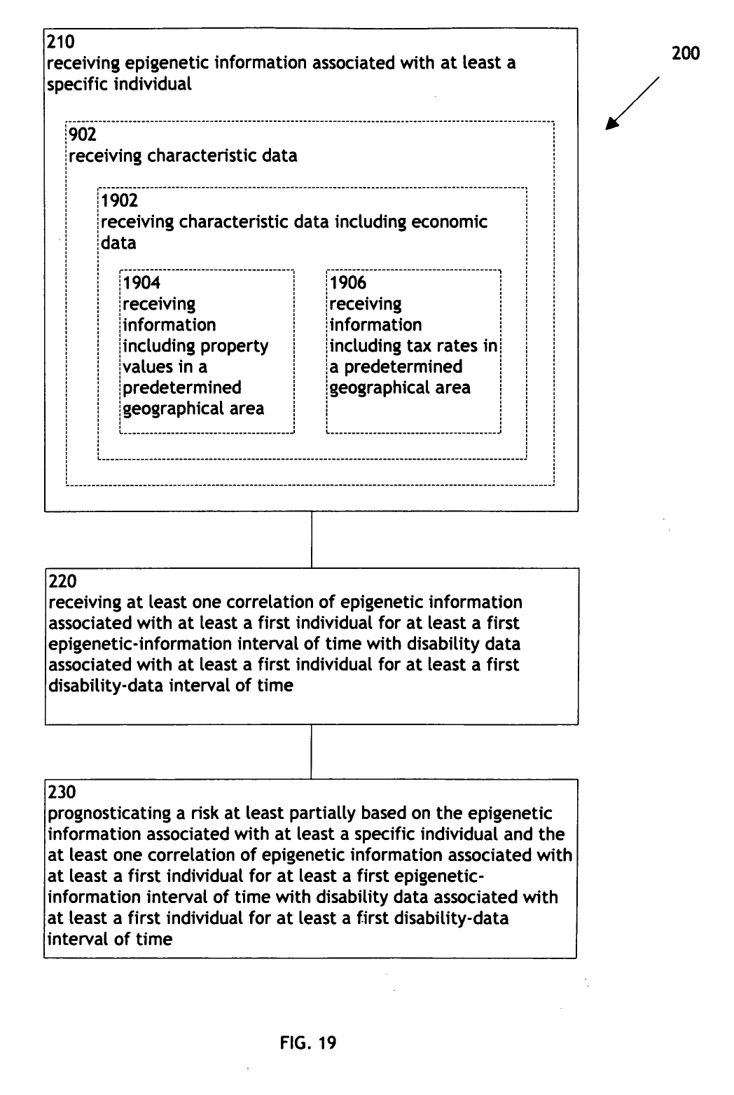

FIG. 19 illustrates alternative embodiments of the example operational flow 200 of FIG. 2. FIG. 19 illustrates example embodiments where the operation 210 may include at least one additional operation. Additional operations may include an operation 1902, an operation 1904, and/or an operation 1906. Further, the operation 1902 illustrates receiving characteristic data including economic data. For example, as shown in FIG. 1, receiver module 102 may receive characteristic data 108 including economic data. In one example, receiver module 102 receives characteristic data 108 including economic data from network storage 110. Economic data may include data pertaining to the production, distribution, and use of income, wealth, and commodities. In some instances, receiver module 102 may include a computer processor. Further, the operation 1904 illustrates receiving information including property values in a predetermined geographical area. For example, as shown in FIG. 1, receiver module 102 may receive information including property values in a predetermined geographical area. In one instance, receiver module 102 receives information including property values in the state of Nevada from network storage 110. A property value may include land value, structure value, home value, and/or building value. In some instances, receiver module 102 may include a computer processor. Further, the operation 1906 illustrates receiving information including tax rates in a predetermined geographical area. For example, as shown in FIG. 1, receiver module 102 may receive information including tax rates in a predetermined geographical area. In one example, receiver module 102 receives information from memory device 112 including tax rates in the city of Portland, Oreg. Some examples of a tax rate may include rates for income tax, sales tax, property tax, consumption tax, gas tax, etc. In some instances, receiver module 102 may include a computer processor.

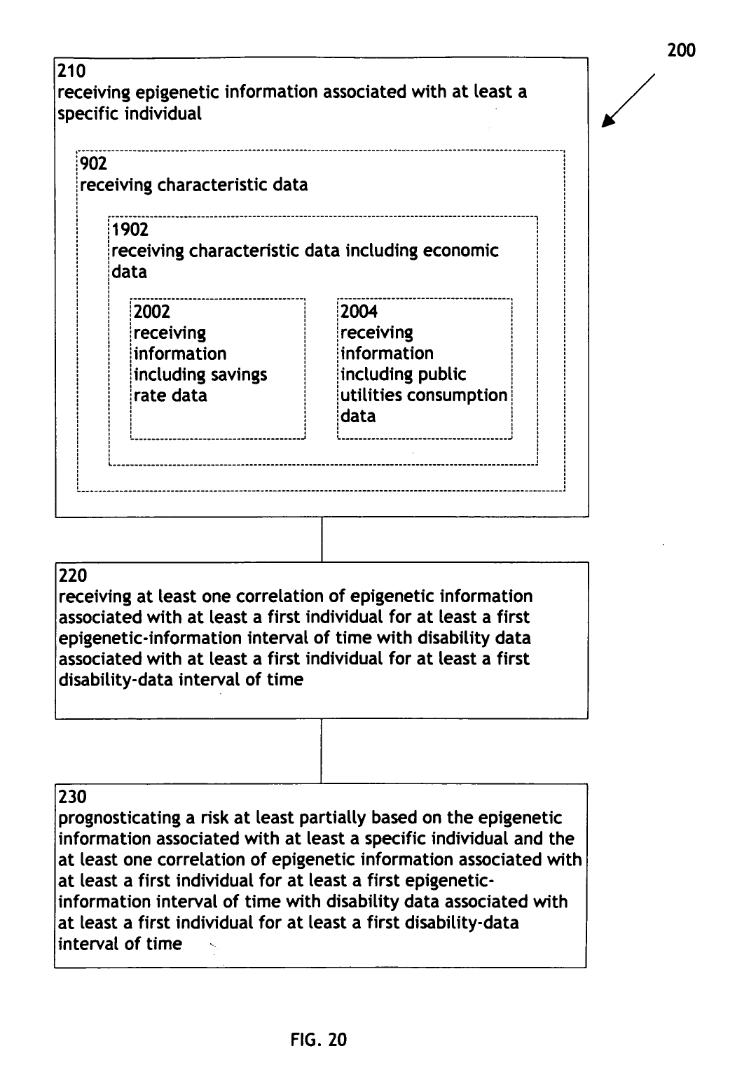

FIG. 20 illustrates alternative embodiments of the example operational flow 200 of FIG. 2. FIG. 20 illustrates example embodiments where the operation 210 may include at least one additional operation. Additional operations may include an operation 2002, and/or an operation 2004. Further, the operation 2002 illustrates receiving information including savings rate data. For example, as shown in FIG. 1, receiver module 102 may receive information including savings rate data. In one instance, receiver module 102 receives information from memory device 112 including savings rate data. Savings rate data may include the rate of money deposited in a passbook savings account and/or the rate of money deposited in a retirement account. In some instances, receiver module 102 may include a computer processor. Further, the operation 2004 illustrates receiving information including public utilities consumption data. For example, as shown in FIG. 1, receiver module 102 may receive information including public utilities consumption data. In one example, receiver module 102 receives information including public utilities consumption data from memory device 112. Public utilities consumption data may include the rate of energy usage including electricity, natural gas, and/or water. In some instances, receiver module 102 may include a computer processor.

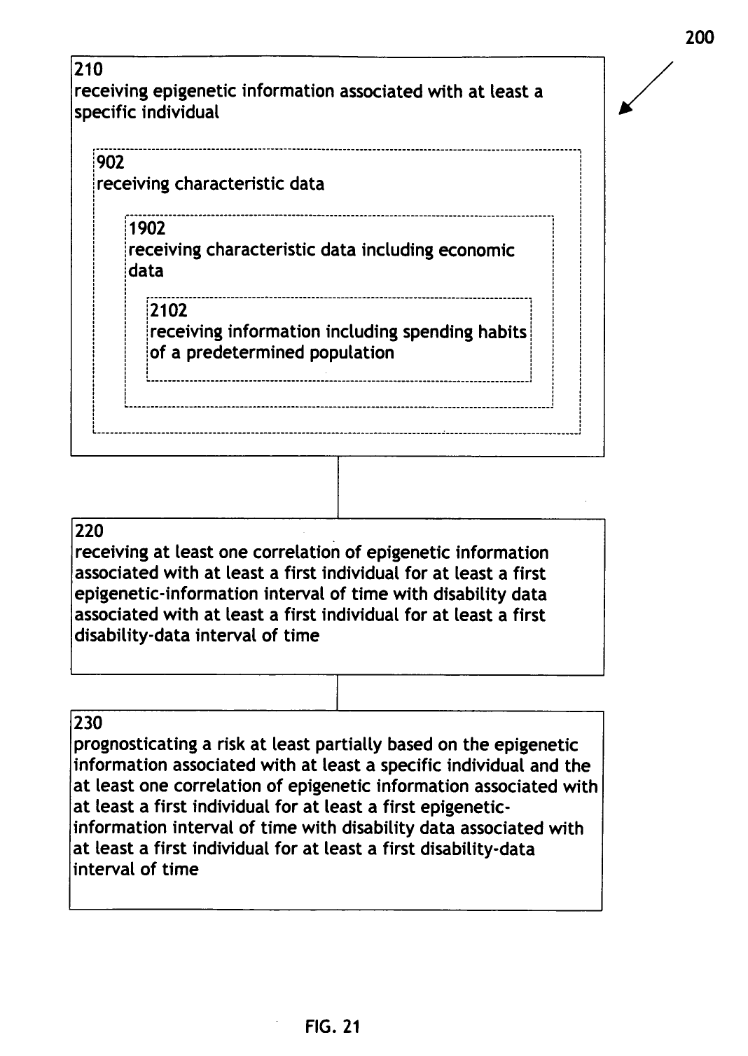

FIG. 21 illustrates alternative embodiments of the example operational flow 200 of FIG. 2. FIG. 21 illustrates example embodiments where the operation 210 may include at least one additional operation. Additional operations may include an operation 2102. Further, the operation 2102 illustrates receiving information including spending habits of a predetermined population. For example, as shown in FIG. 1, receiver module 102 may receive information including spending habits of a predetermined population. In one instance, receiver module 102 receives information from database entry 114 including the spending habits of California during the months of November and December. The spending habits of a predetermined population may include examples such as retail sales, holiday spending, spending on credit, and/or vehicle sales. In some instances, receiver module 102 may include a computer processor.

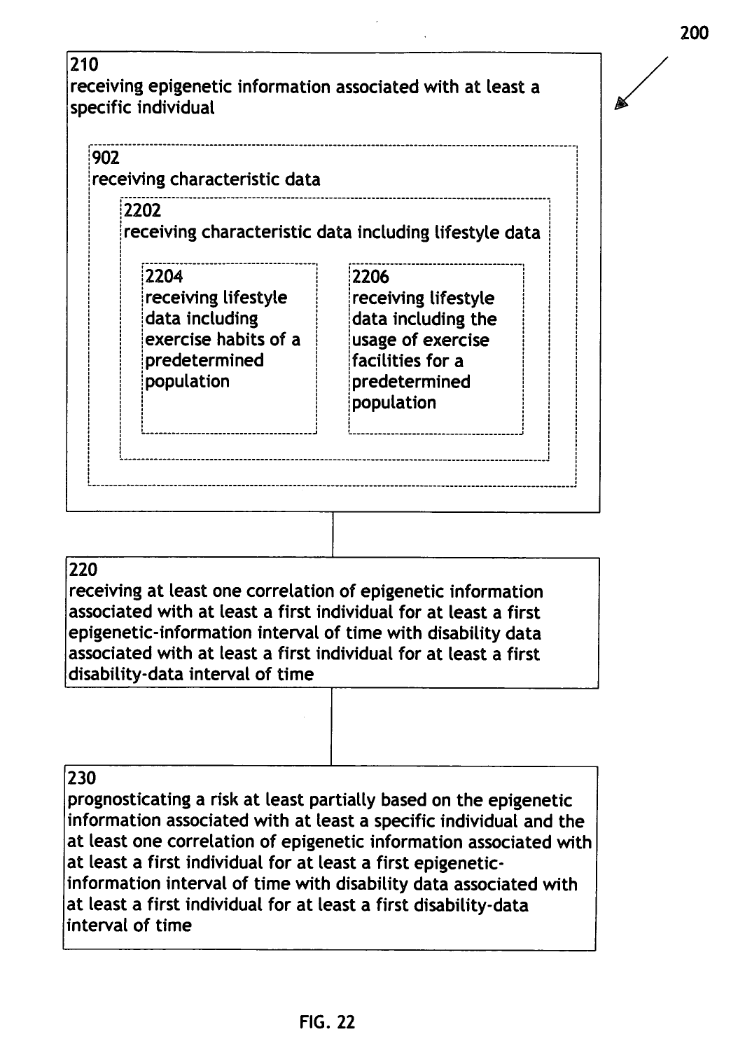

FIG. 22 illustrates alternative embodiments of the example operational flow 200 of FIG. 2. FIG. 22 illustrates example embodiments where the operation 210 may include at least one additional operation. Additional operations may include an operation 2202, an operation 2204, and/or an operation 2206. Further, the operation 2202 illustrates receiving characteristic data including lifestyle data. For example, as shown in FIG. 1, receiver module 102 may receive characteristic data 108 including lifestyle data. Lifestyle data may include data related to habits, attitudes, economic level, moral standards, manner of living, fashions, and/or style for an individual and/or group. In one example, receiver module 102 receives lifestyle data including food consumption data for the state of Maryland from database entry 114. In some instances, receiver module 102 may include a computer processor. Further, the operation 2204 illustrates receiving lifestyle data including exercise habits of a predetermined population. For example, as shown in FIG. 1, receiver module 102 may receive lifestyle data including exercise habits of a predetermined population. In one instance, receiver module 102 receives lifestyle data including exercise habits of the population of Florida from network storage 110. Exercise habits of a predetermined population may include sales data of exercise equipment and/or nutritional supplements, participation in athletic events, such as a marathon, and/or the number of exercise facilities within a geographical area and/or location. In some instances, receiver module 102 may include a computer processor. Further, the operation 2206 illustrates receiving lifestyle data including the usage of exercise facilities for a predetermined population. For example, as shown in FIG. 1, receiver module 102 may receive lifestyle data including the usage of exercise facilities for a predetermined population. In a specific example, receiver module 102 receives lifestyle data including the usage of exercise facilities for Miami, Fla. from network storage 110. The usage of exercise facilities may include the number of club memberships in a certain location and/or for a certain population, the number of people visiting an exercise facility at a certain location, and/or the number of people enrolled at a diet center. In some instances, receiver module 102 may include a computer processor.

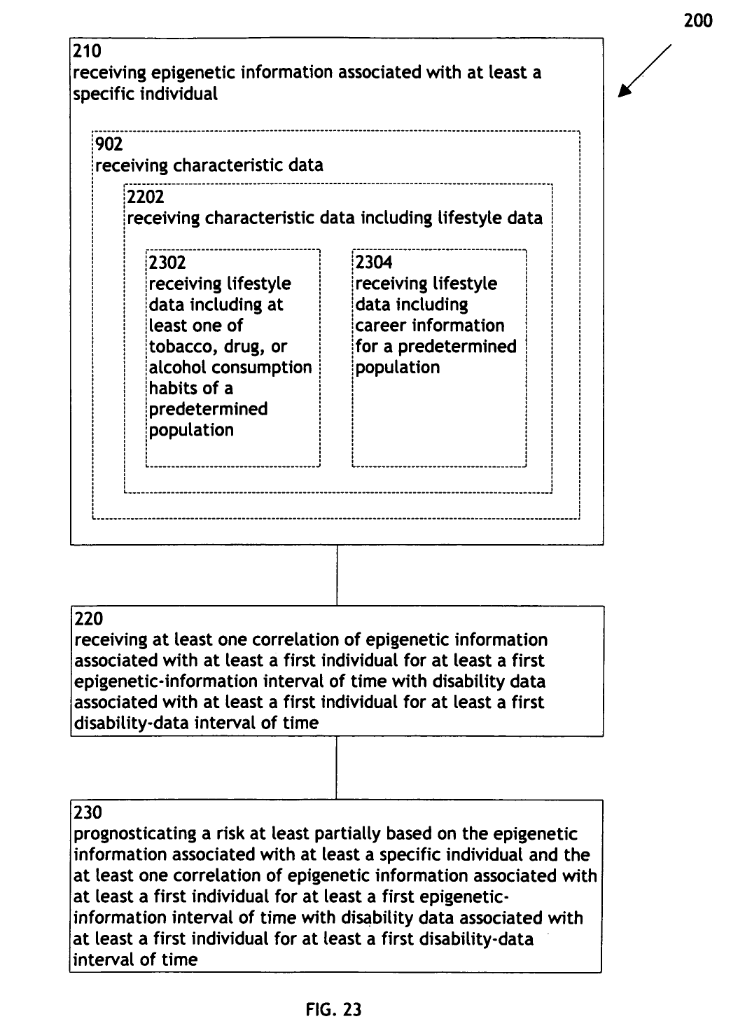

FIG. 23 illustrates alternative embodiments of the example operational flow 200 of FIG. 2. FIG. 23 illustrates example embodiments where the operation 210 may include at least one additional operation. Additional operations may include an operation 2302, and/or an operation 2304. Further, the operation 2302 illustrates receiving lifestyle data including at least one of tobacco, drug, or alcohol consumption habits of a predetermined population. For example, as shown in FIG. 1, receiver module 102 may receive lifestyle data including at least one of tobacco, drug, or alcohol consumption habits of a predetermined population. In a specific example, receiver module 102 receives lifestyle data including tobacco consumption habits for Detroit, Mich. from wireless communication link 116. Alcohol consumption habit data may include data regarding alcohol sales, the number of bars and/or nightclubs in a certain area, the rate of DUI stops in a certain location, and/or the occurrence of Alcoholics Anonymous meetings. A tobacco habit may include tobacco sales for a geographic location. Data associated with a drug habit may include data including over-the-counter and/or prescription drug sales, doctor prescriptions, illegal drug arrests, and/or illegal drug convictions. In some instances, receiver module 102 may include a computer processor. Further, the operation 2304 illustrates receiving lifestyle data including career information for a predetermined population. For example, as shown in FIG. 1, receiver module 102 may receive lifestyle data including career information for a predetermined population. In one example, receiver module 102 receives lifestyle data including career information for the District of Columbia from wireless communication link 116. Career information data may include unemployment rates, the types of industry, the amount of professionals, and or the average age of employees in a geographic area. In some instances, receiver module 102 may include a computer processor.

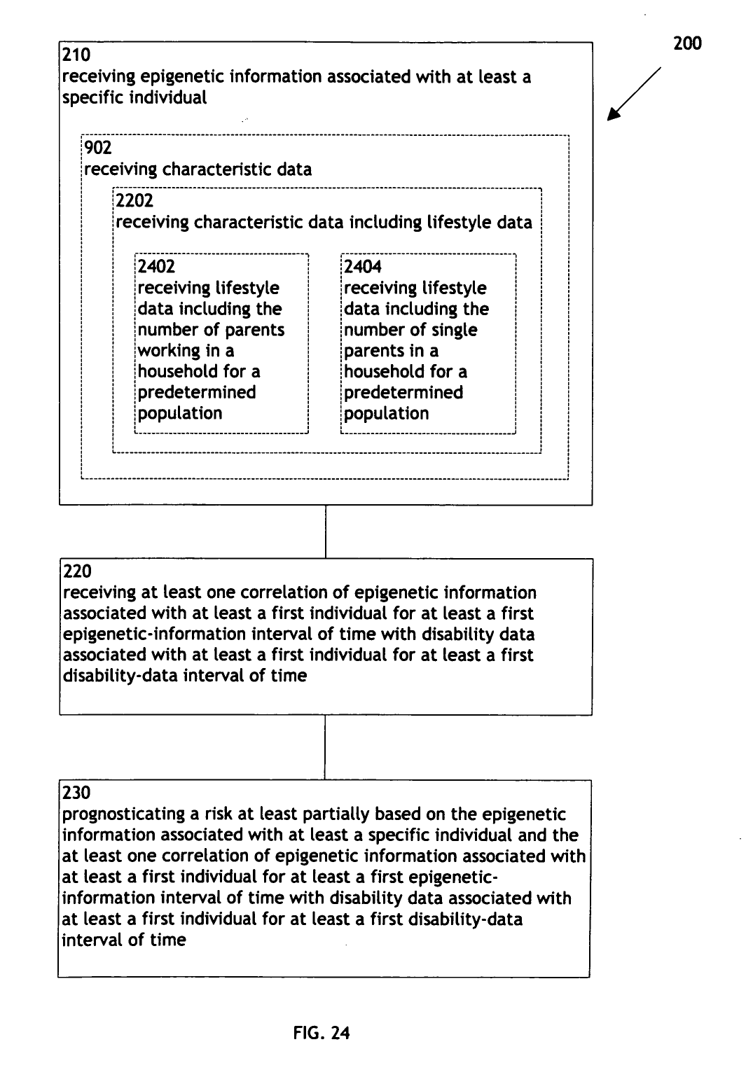

FIG. 24 illustrates alternative embodiments of the example operational flow 200 of FIG. 2. FIG. 24 illustrates example embodiments where the operation 210 may include at least one additional operation. Additional operations may include an operation 2402, and/or an operation 2404. Further, the operation 2402 illustrates receiving lifestyle data including the number of working parents in a household for a predetermined population. For example, as shown in FIG. 1, receiver module 102 may receive lifestyle data including the number of working parents in a household for a predetermined population. In one instance, receiver module 102 receives lifestyle data from network storage 110 including the number of working parents residing in a household for San Francisco, Calif. In some instances, receiver module 102 may include a computer processor. Further, the operation 2404 illustrates receiving lifestyle data including the number of single parents in a household for a predetermined population. For example, as shown in FIG. 1, receiver module 102 may receive lifestyle data including the number of single parents in a household for a predetermined population. In one example, receiver module 102 receives lifestyle data from memory device 112 including the number of single parents in a household for Phoenix, Ariz. A single parent may include a divorced parent, a separated parent, a parent living alone, and/or a parent never before married. In some instances, receiver module 102 may include a computer processor.

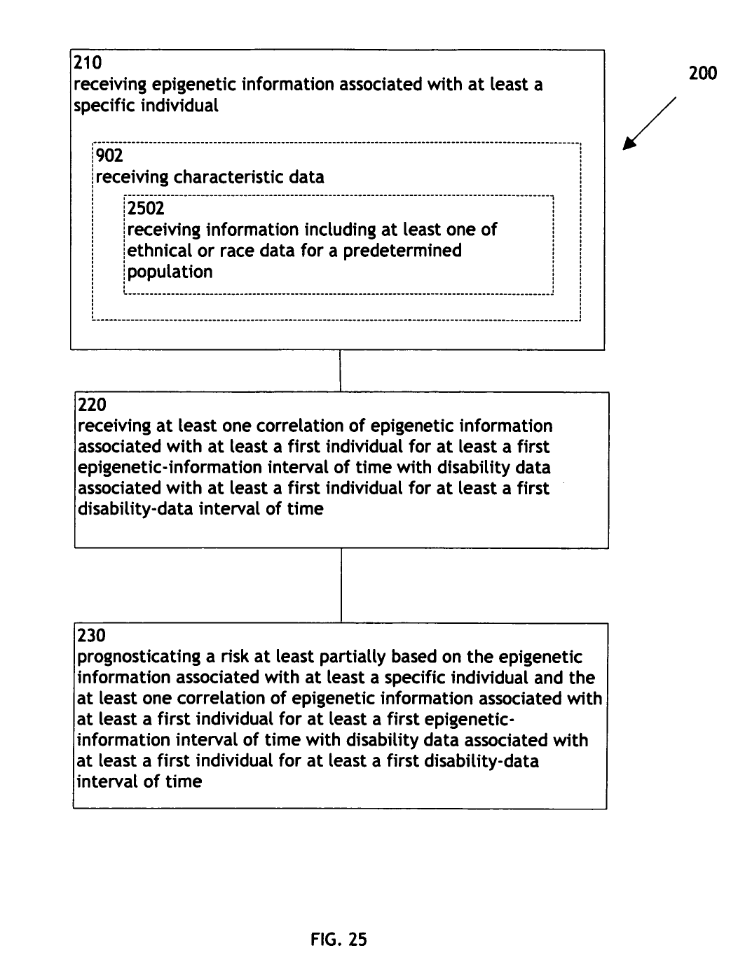

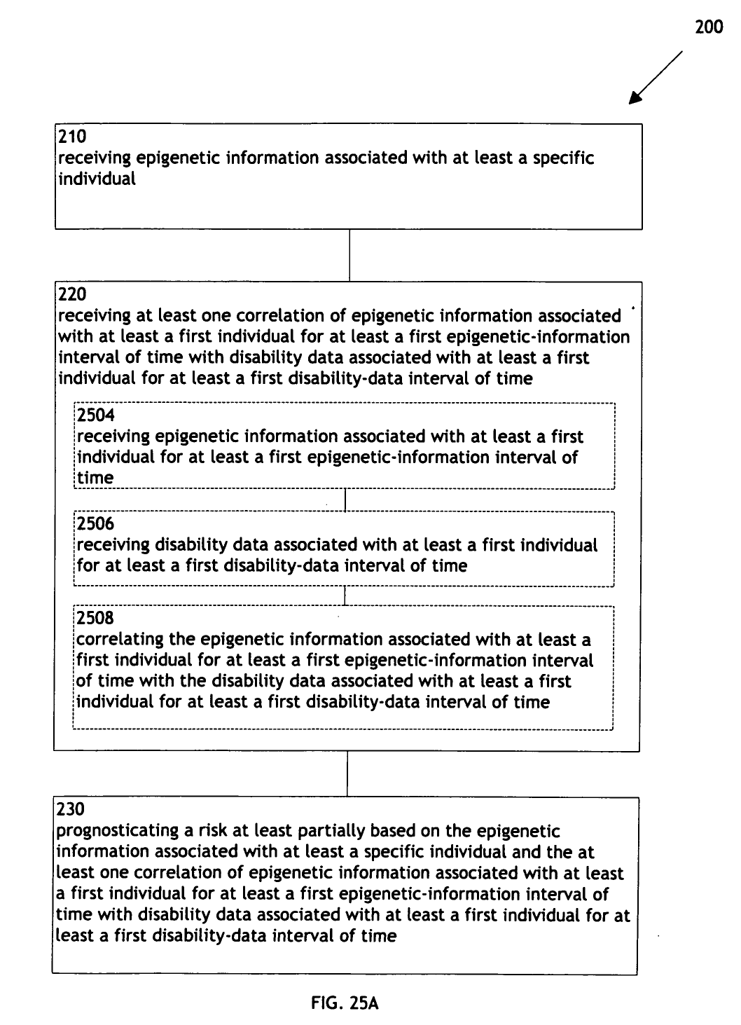

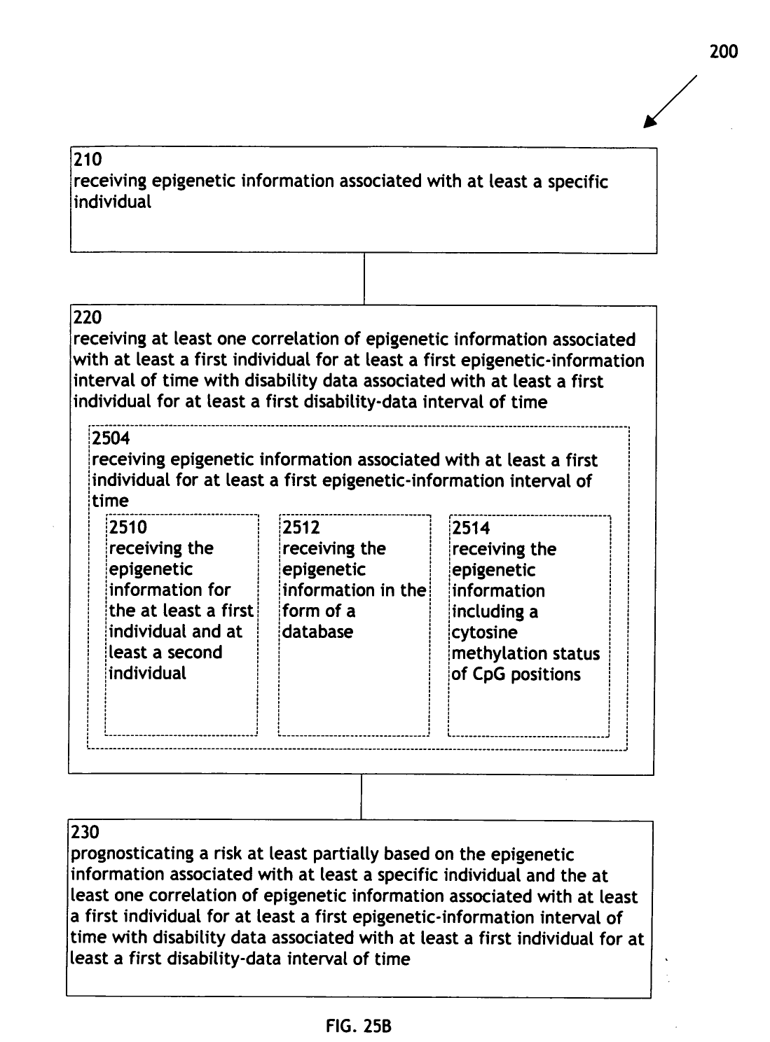

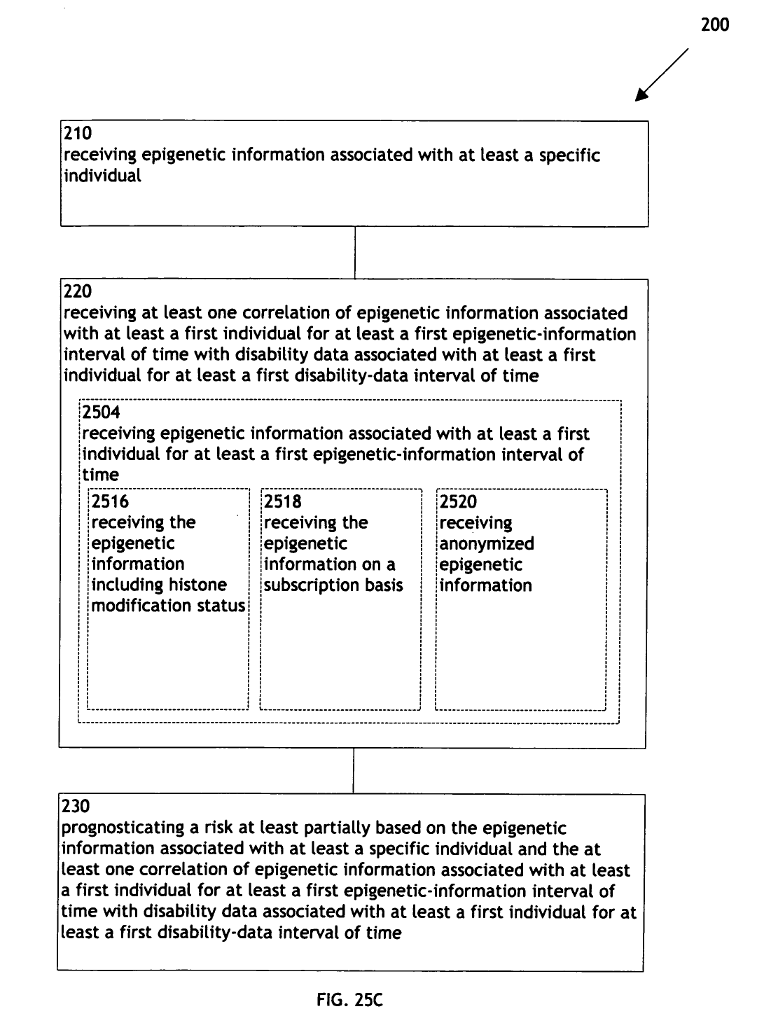

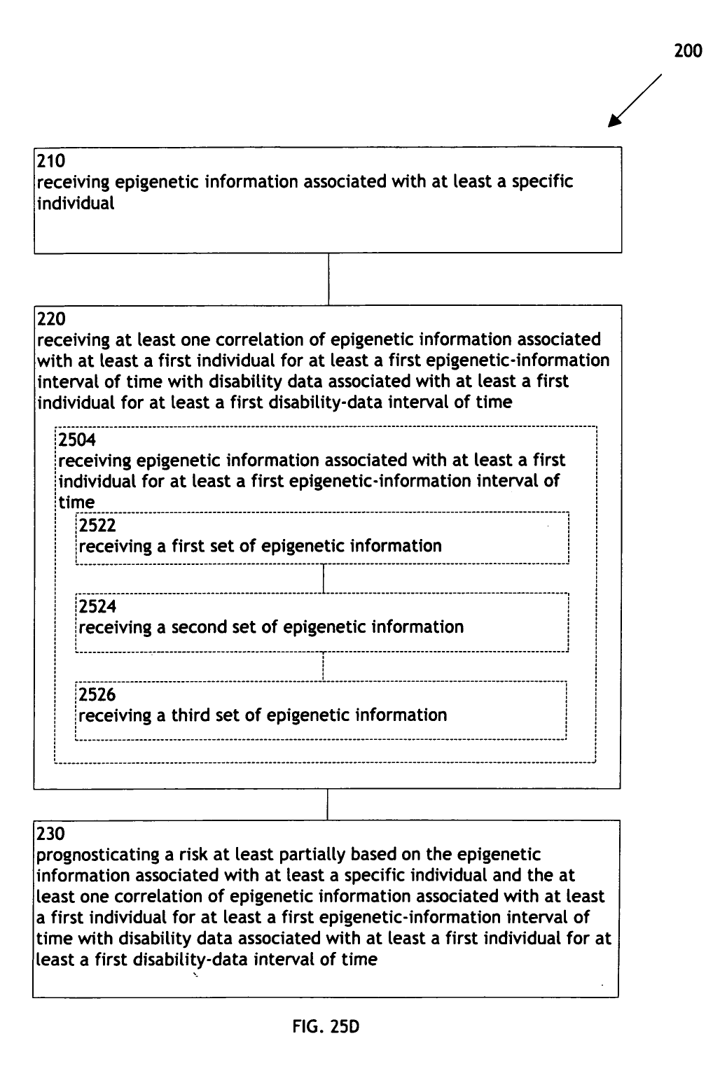

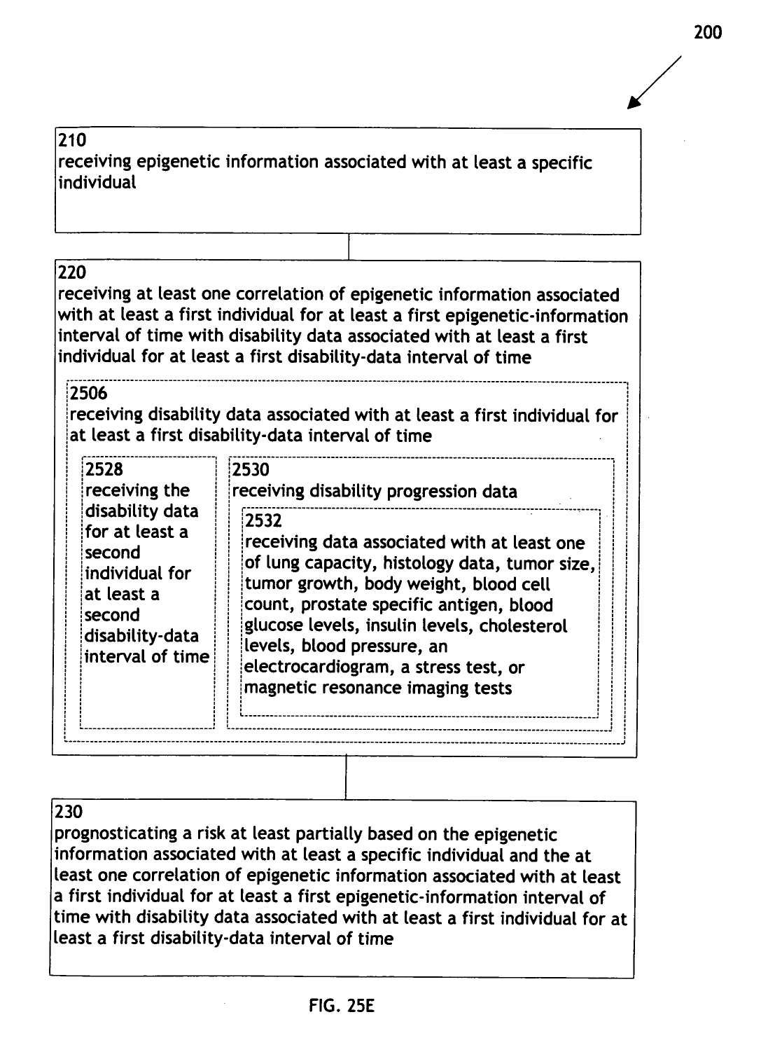

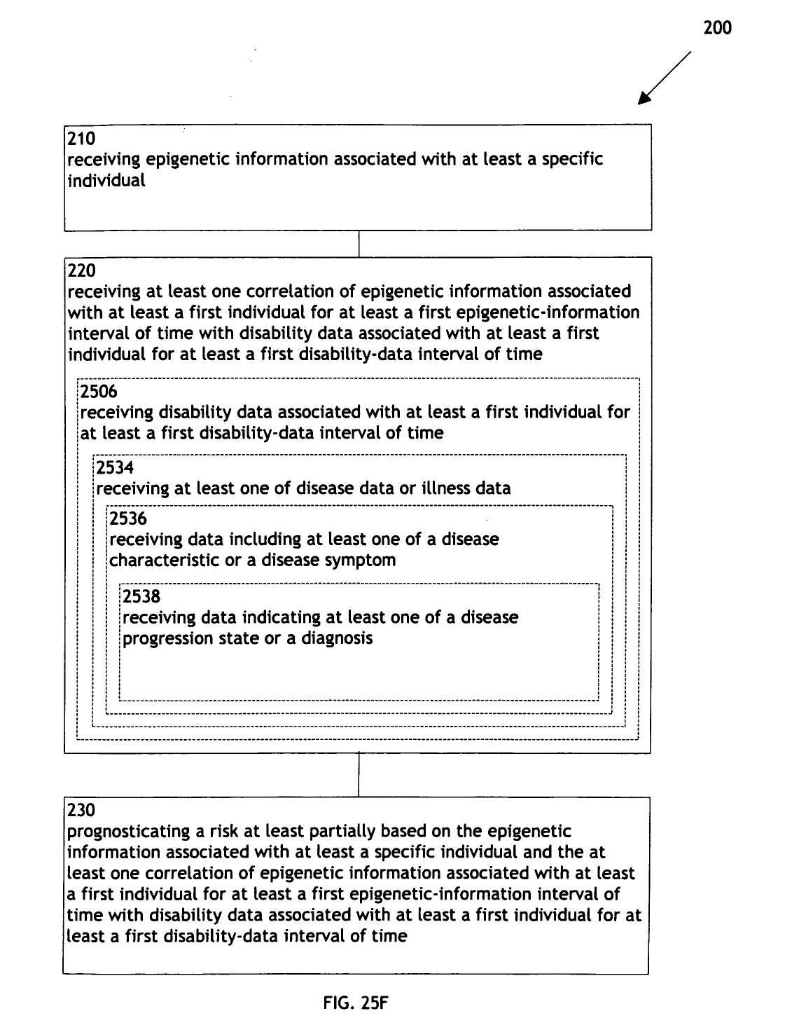

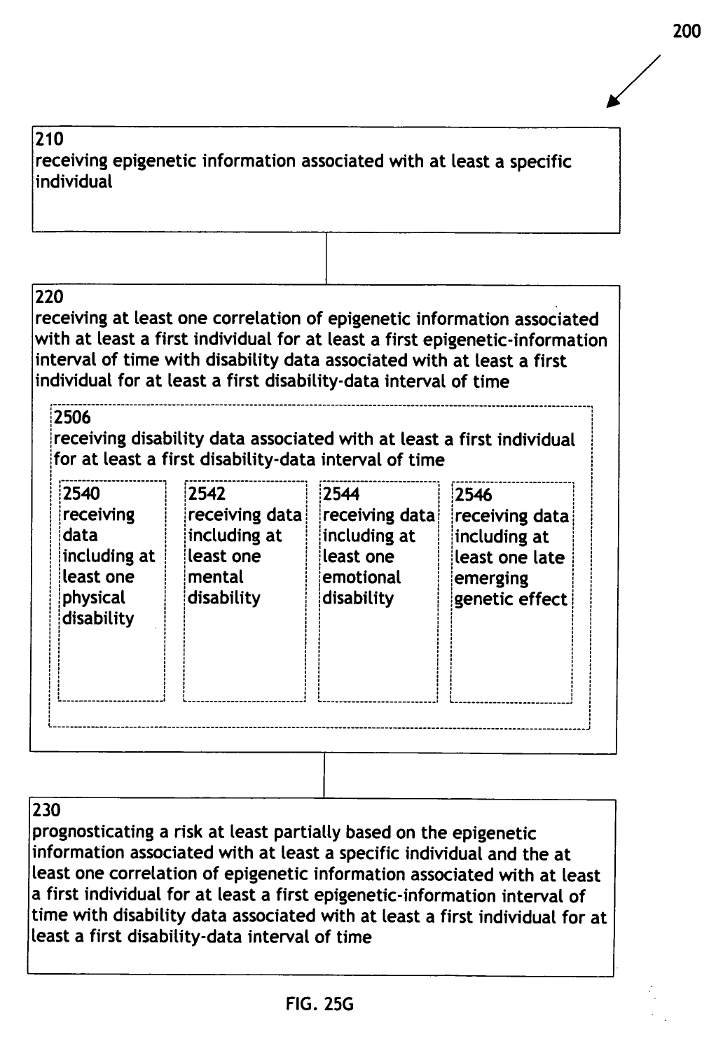

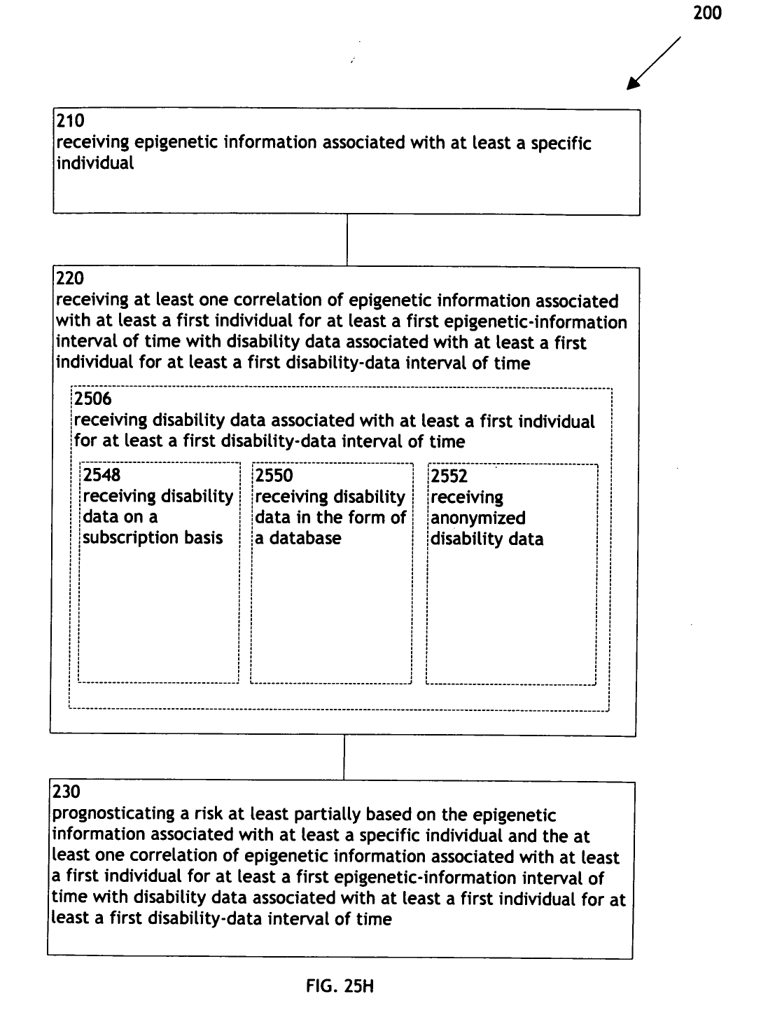

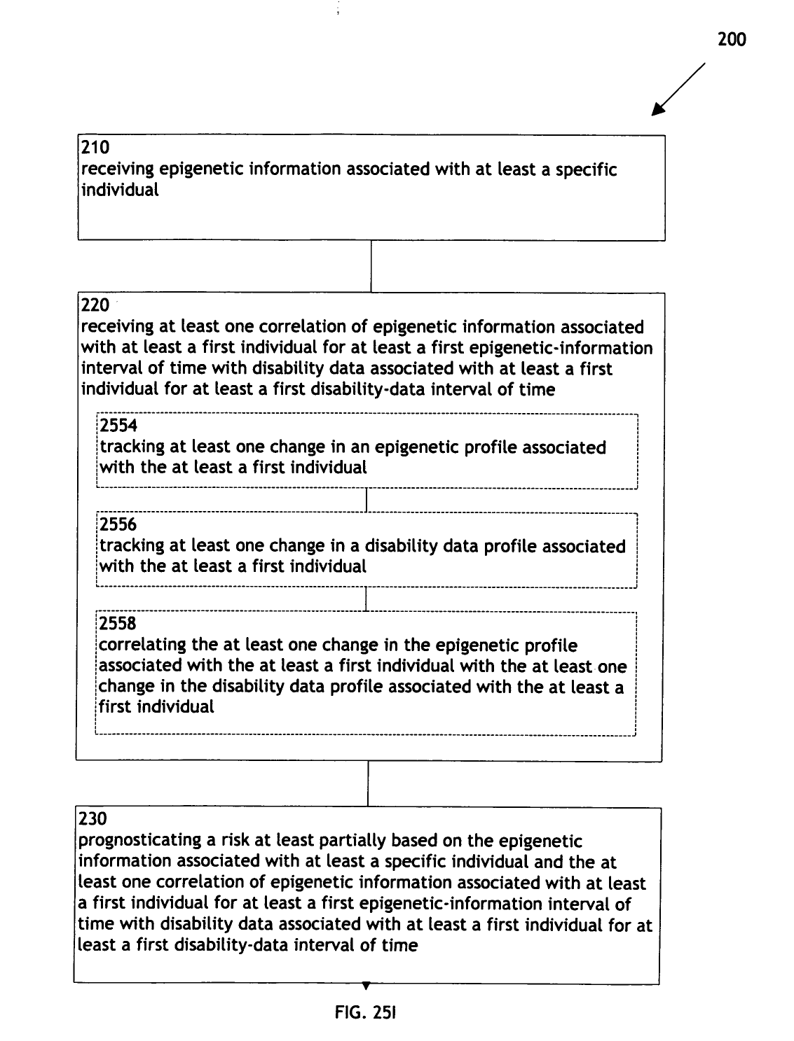

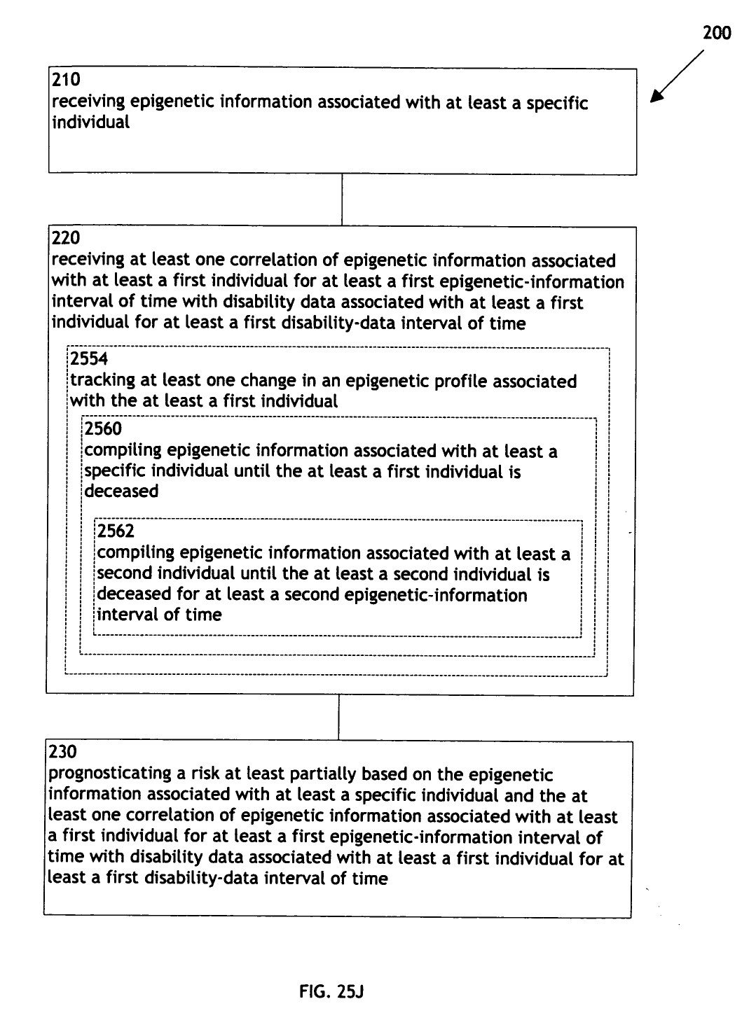

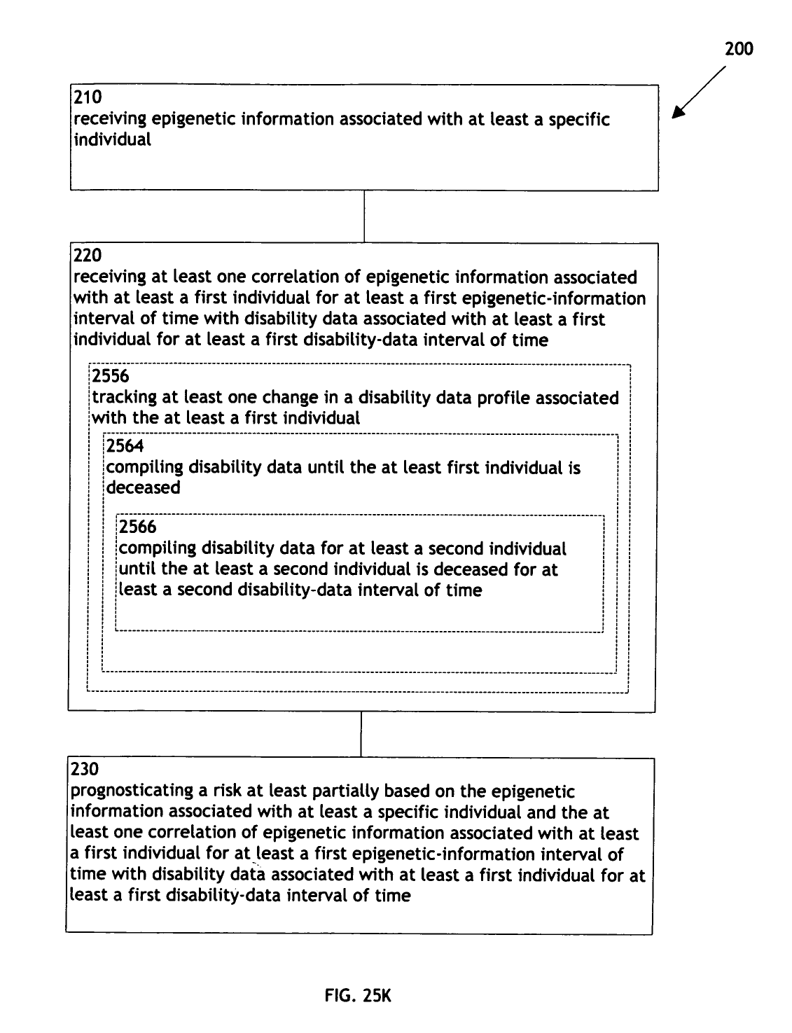

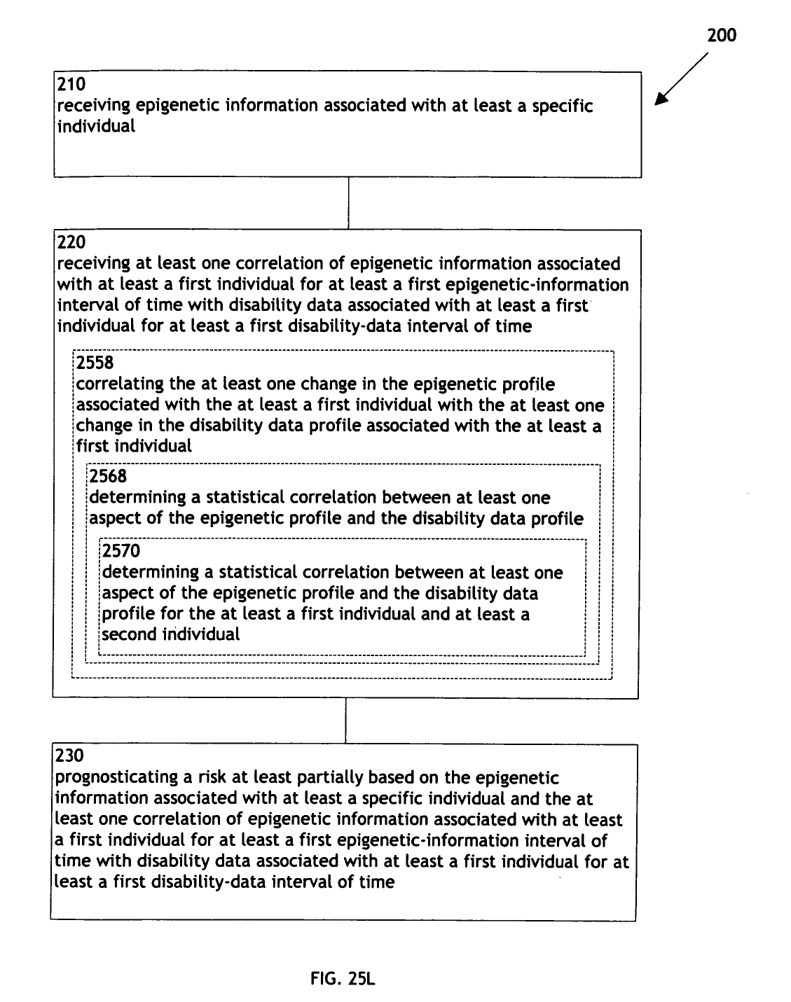

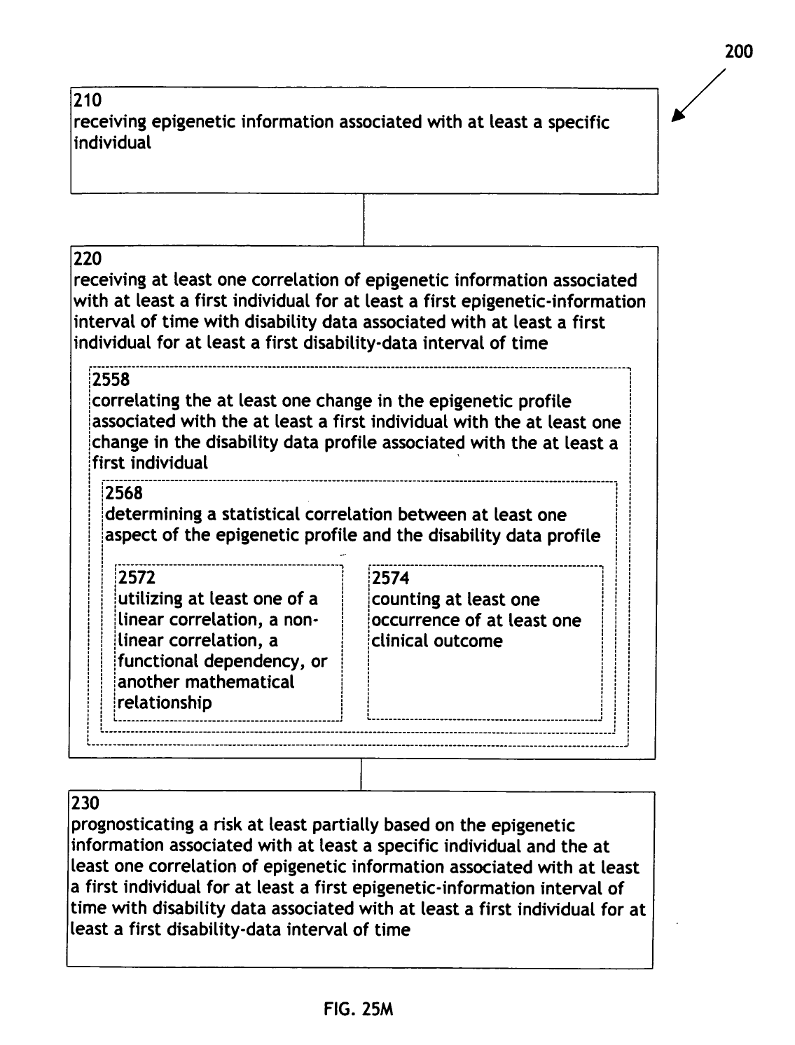

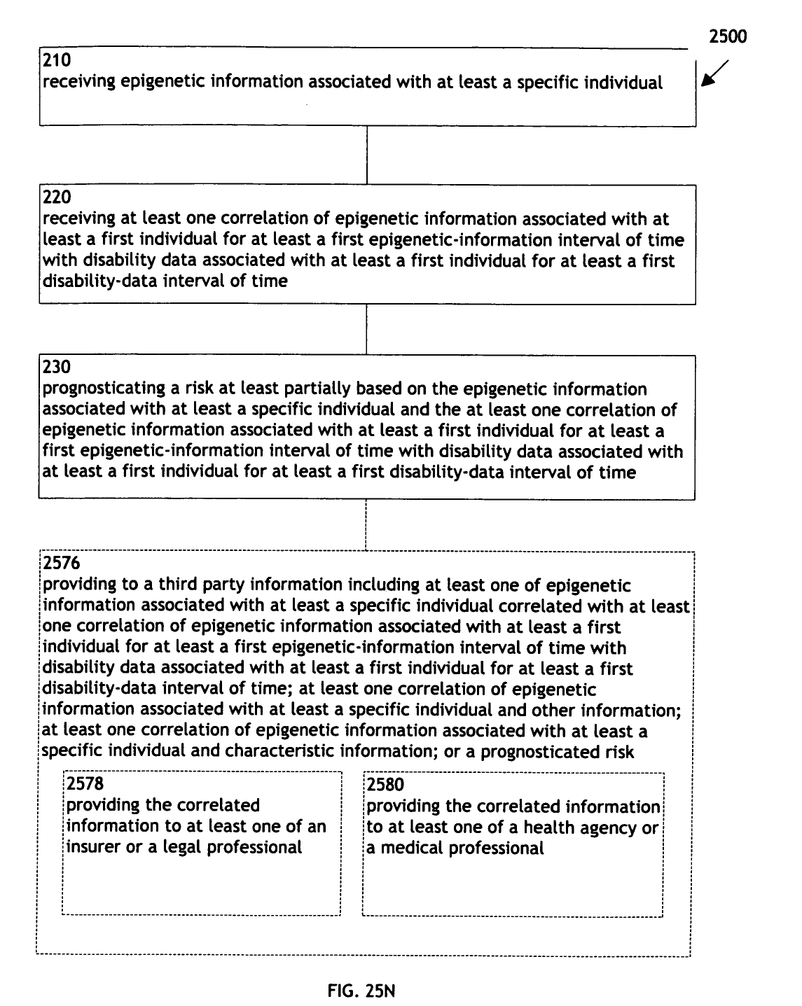

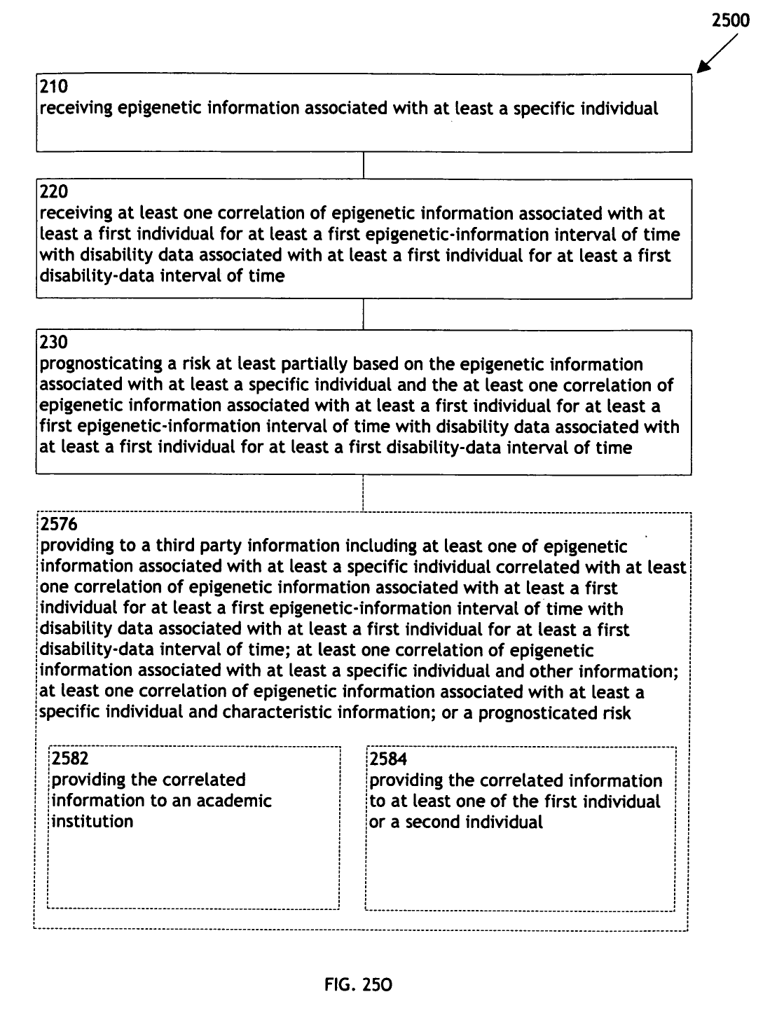

FIG. 25 illustrates alternative embodiments of the example operational flow 200 of FIG. 2. FIG. 25 illustrates example embodiments where the operation 210 may include at least one additional operation. Additional operations may include an operation 2502. Further, the operation 2502 illustrates receiving information including at least one of ethnical or race data for a predetermined population. For example, as shown in FIG. 1, receiver module 102 may receive information including at least one of ethnical or race data for a predetermined population. In one instance, receiver module 102 receives information from database entry 114 including ethnical data for New York City. Ethnical and/or race data may include numbers and/or distributions of a certain population ethnicity and/or population race. In some instances, receiver module 102 may include a computer processor.

FIG. 25A illustrates alternative embodiments of the example operational flow 200 of FIG. 2. FIG. 25A illustrates example embodiments where the receiving at least one correlation of epigenetic information associated with at least a first individual for at least a first epigenetic-information interval of time with disability data associated with at least a first individual for at least a first disability-data interval of time operation 220 may include at least one additional operation. Additional operations may include an operation 2504, an operation 2506, and/or an operation 2508.

Operation 2504 illustrates receiving epigenetic information associated with at least a first individual for at least a first epigenetic-information interval of time. For example, as shown in FIG. 1, receiver module 102 may receive epigenetic information associated with at least a first individual for at least a first epigenetic-information interval of time. In one specific example, receiver module 102 receives from network storage 110 for a first individual named John Smith epigenetic information for a period of time spanning from Jan. 1, 1980 to the death of John Smith on Jan. 1, 2000. Some explanation regarding epigenetic information 106 may be found in sources such as Bird, Perceptions of Epigenetics, NATURE 477, 396-398 (2007); Grewal and Elgin, Transcription and RNA Interference in the Formation of Heterochromatin, NATURE 447: 399-406 (2007); and Callinan and Feinberg, The Emerging Science of Epigenomics, HUMAN MOLECULAR GENETICS 15, R95-R11 (2006), each of which are incorporated herein by reference. Epigenetic information may include, for example, information regarding DNA methylation, histone states or modifications, transcriptional activity, RNAi, protein binding or other molecular states. Further, epigenetic information may include information regarding inflammation-mediated cytosine damage products. See, e.g., Valinluck and Sowers, Inflammation-Mediated Cytosine Damage: A Mechanistic Link Between Inflammation and the Epigenetic Alterations in Human Cancers, CANCER RESEARCH 67: 5583-5586 (2007), which is incorporated herein by reference. In some instances, receiver module 102 may include a computer processor. Proper nouns and/or names used herein are meant to be exemplary only.

Operation 2506 illustrates receiving disability data associated with at least a first individual for at least a first disability-data interval of time. For example, as shown in FIG. 1, receiver module 102 may receive disability data associated with at least a first individual for at least a first disability-data interval of time. In one specific instance and continuing with the example above, receiver module 102 receives from memory device 112 disability data for an individual named John Smith for a period of time spanning from Jan. 1, 1980 to the death of John Smith on Jan. 1, 2000. In some instances, receiver module 102 may include a computer processor.

Operation 2508 illustrates correlating the epigenetic information associated with at least a first individual for at least a first epigenetic-information interval of time with the disability data associated with at least a first individual for at least a first disability-data interval of time. For example, as shown in FIG. 1, correlator module 142 may correlate the epigenetic information associated with at least a first individual for at least a first epigenetic-information interval of time and the disability data associated with at least a first individual for at least a first disability-data interval of time. In a specific instance and continuing with the example above, correlator module 142 correlates the epigenetic information received for John Smith pertaining to a period of time spanning from Jan. 1, 1980 to the death of John Smith on Jan. 1, 2000 with the disability data received for John Smith pertaining to a period of time spanning from Jan. 1, 1980 to the death of John Smith on Jan. 1, 2000. In some instances, correlator module 142 may include a computer processor.

FIG. 25B illustrates alternative embodiments of the example operational flow 200 of FIG. 2. FIG. 25B illustrates example embodiments where the receiving at least one correlation of epigenetic information associated with at least a first individual for at least a first epigenetic-information interval of time with disability data associated with at least a first individual for at least a first disability-data interval of time operation 220 may include at least one additional operation. Additional operations may include an operation 2510, an operation 2512, and/or an operation 2514.

Operation 2510 illustrates receiving the epigenetic information for the at least a first individual and at least a second individual. For example, as shown in FIG. 1, receiver module 102 may receive epigenetic information for the at least a first individual and at least a second individual. In one specific instance, receiver module 102 receives epigenetic information regarding a certain DNA methylation status from database entry 114 for a first individual named Robert Green and for a second individual named William Green. The at least a first individual and the at least a second individual may or may not have a blood relationship and/or a familial relationship. In some instances, receiver module 102 may include a computer processor.

Operation 2512 illustrates receiving the epigenetic information in the form of a database. For example, as shown in FIG. 1, receiver module 102 may receive the epigenetic information in the form of a database. In one specific instance, receiver module 102 receives from wireless communication link 116 the epigenetic information in the form of a database. A database may include a collection of data organized for convenient access. The database may include information digitally stored in a memory device 112, as at least a portion of at least one database entry 114 and/or in network storage 110. In some instances, the database may include information stored non-digitally such as at least a portion of a book, a paper file, and/or a non-computerized index and/or catalog. Non-computerized information may be received by receiver module 102 by scanning or manually entering the information into a digital format. In some instances, receiver module 102 may include a computer processor.

Operation 2514 illustrates receiving the epigenetic information including a cytosine methylation status of CpG positions. For example, as shown in FIG. 1, receiver module 102 may receive the epigenetic information including a cytosine methylation status of CpG positions. In one specific instance, receiver module 102 receives from network storage 110 the epigenetic information including a cytosine methylation status of CpG positions. DNA methylation and cytosine methylation status of CpG positions for an individual may include information regarding the methylation status of DNA generally or in the aggregate, or information regarding DNA methylation at one or more specific DNA loci, DNA regions, or DNA bases. See, for example: Shilatifard, Chromatin modifications by methylation and ubiquitination: implications in the regulation of gene expression, ANNUAL REVIEW OF BIOCHEMISTRY, 75:243-269 (2006); and Zhu and Yao, Use of DNA methylation for cancer detection and molecular classification, JOURNAL OF BIOCHEMISTRY AND MOLECULAR BIOLOGY, 40:135-141 (2007), each of which are incorporated herein by reference. In some instances, receiver module 102 may include a computer processor.

FIG. 25C illustrates alternative embodiments of the example operational flow 200 of FIG. 2. FIG. 25C illustrates example embodiments where the receiving at least one correlation of epigenetic information associated with at least a first individual for at least a first epigenetic-information interval of time with disability data associated with at least a first individual for at least a first disability-data interval of time operation 220 may include at least one additional operation. Additional operations may include an operation 2516, an operation 2518, and/or an operation 2520.

Operation 2516 illustrates receiving the epigenetic information including histone modification status. For example, as shown in FIG. 1, receiver module 102 may receive epigenetic information including histone modification status. In one specific example, receiver module 102 receives from memory device 112 epigenetic information including a histone modification status for a group of individuals. Information regarding histone structure may, for example, include information regarding specific subtypes or classes of histones, such as H1, H2A, H2B, H3 or H4. Information regarding histone structure may have an origin in array-based techniques, such as described in Barski et al., High-resolution profiling of histone methylations in the human genome, CELL 129, 823-837 (2007), which is incorporated herein by reference. In some instances, receiver module 102 may include a computer processor.

Operation 2518 illustrates receiving the epigenetic information on a subscription basis. For example, as shown in FIG. 1, receiver module 102 may receive the epigenetic information on a subscription basis. In a specific example, receiver module 102 may receive from database entry 114 the epigenetic information on a subscription basis for a period of one year. A subscription may include an agreement to receive and/or be given access to the epigenetic information. The subscription may include access to epigenetic information in a digital form and/or a physical form of information, such as paper printouts. In some instances, receiver module 102 may include a computer processor.

Operation 2520 illustrates receiving anonymized epigenetic information. For example, as shown in FIG. 1, receiver module 102 may receive anonymized epigenetic information. In one instance, receiver module 102 receives from wireless communication link 116 anonymized epigenetic information. Anonymized epigenetic information may be received for more than one individual, such as a group of two hundred individuals. Anonymized epigenetic information may be anonymized in different degrees and by different methods. Different degrees of anonymization may include full anonymization and/or partial anonymization, such as in the case of pseudonym utilization. Methods for anonymizing epigenetic information may include the use of cell suppression and/or utilizing anonymization algorithms. In some instances, receiver module 102 may include a computer processor.

FIG. 25D illustrates alternative embodiments of the example operational flow 200 of FIG. 2. FIG. 25D illustrates example embodiments where the receiving at least one correlation of epigenetic information associated with at least a first individual for at least a first epigenetic-information interval of time with disability data associated with at least a first individual for at least a first disability-data interval of time operation 220 may include at least one additional operation. Additional operations may include an operation 2522, an operation 2524, and/or an operation 2526.

Operation 2522 illustrates receiving a first set of epigenetic information. For example, as shown in FIG. 1, receiver module 102 may receive a first set of epigenetic information. In one specific instance, receiver module 102 receives from network storage 110 a first set of epigenetic information regarding a specific histone structure modification. A set of information may include a set amount of information and both terms may be used interchangeably herein. Further, a set of information may include batch, finite, and/or discrete amounts information. Additionally, epigenetic information may be received for more than one individual. Then, operation 2524 illustrates receiving a second set of epigenetic information. For example, as shown in FIG. 1, receiver module 102 may receive a second set of epigenetic information. In one specific instance, receiver module 102 receives from network storage 110 a second set of epigenetic information regarding a specific histone structure modification. Further, operation 2526 receiving a third set of epigenetic information. For example, as shown in FIG. 1, receiver module 102 may receive a third set of epigenetic information. In one specific instance, receiver module 102 receives from network storage 110 a third set of epigenetic information regarding a specific histone structure modification. Additional sets of information may be received by receiver module 102 as batches or finite sets beyond the first, second, and third set of epigenetic information. In some instances, receiver module 102 may include a computer processor.

FIG. 25E illustrates alternative embodiments of the example operational flow 200 of FIG. 2. FIG. 25E illustrates example embodiments where the receiving at least one correlation of epigenetic information associated with at least a first individual for at least a first epigenetic-information interval of time with disability data associated with at least a first individual for at least a first disability-data interval of time operation 220 may include at least one additional operation. Additional operations may include an operation 2528, an operation 2530, and/or an operation 2532.

Operation 2528 illustrates receiving the disability data for at least a second individual for at least a second disability-data interval of time. For example, as shown in FIG. 1, receiver module 102 may receive the disability data for at least a second individual for at least a first disability-data interval of time. In one specific instance, receiver module 102 receives from memory device 112 disability data for a first individual named Ron Wilson and a second individual named Robert Jones for a period of time from Jan. 5, 2000 until the deaths of Ron Wilson and Robert Jones. In some instances, receiver module 102 may include a computer processor.

Operation 2530 illustrates receiving disability progression data. For example, as shown in FIG. 1, receiver module 102 may receive disability progression data. In one specific instance, receiver module 102 receives from database entry 114 disability progression data indicating the progression of lung disease for a group of people in a specific geographical area. Disability progression data may include data indicating the progression of a disability, illness, and/or disease. In some instances, receiver module 102 may include a computer processor. Further, operation 2532 illustrates receiving data associated with at least one of lung capacity, histology data, tumor size, tumor growth, body weight, blood cell count, prostate specific antigen, blood glucose levels, insulin levels, cholesterol levels, blood pressure, an electrocardiogram, a stress test, or magnetic resonance imaging test. For example, as shown in FIG. 1, receiver module 102 may receive data associated with at least one of lung capacity, histology data, tumor size, tumor growth, body weight, blood cell count, prostate specific antigen, blood glucose levels, insulin levels, cholesterol levels, blood pressure, an electrocardiogram, a stress test, or magnetic resonance imaging tests. In one specific instance, receiver module 102 receives from wireless communications link 116 data including the amount of tumor growth, the size of a tumor, and lung capacity for a person having lung cancer. In another specific instance, receiver module 102 receives from wireless communications link 116 data including an insulin level and a blood glucose level for a person having diabetes. In another specific instance, receiver module 102 receives from wireless communications link 116 data including an electrocardiogram for a person having coronary heart disease. In some instances, receiver module 102 may include a computer processor.

FIG. 25F illustrates alternative embodiments of the example operational flow 200 of FIG. 2. FIG. 25F illustrates example embodiments where the receiving at least one correlation of epigenetic information associated with at least a first individual for at least a first epigenetic-information interval of time with disability data associated with at least a first individual for at least a first disability-data interval of time operation 220 may include at least one additional operation. Additional operations may include an operation 2534, an operation 2536, and/or an operation 2538.

Operation 2534 illustrates receiving at least one of disease data or illness data. For example, as shown in FIG. 1, receiver module 102 may receive at least one of disease data or illness data. In one specific instance, receiver module 102 receives from database entry 114 disease data indicating the occurrence of lung disease for a specific geographical area and illness data indicating the occurrence of pneumonia for the same geographical area. In some instances, receiver module 102 may include a computer processor. Further, operation 2536 illustrates receiving data including at least one of a disease characteristic or a disease symptom. For example, as shown in FIG. 1, receiver module 102 may receive data including at least one of a disease characteristic or a disease symptom. In one specific instance, receiver module 102 receives from wireless communication link 116 data including a disease characteristic, such as the abnormal proliferation of white blood cells, indicating a likelihood of leukemia. Disease characteristics and/or disease symptoms may include indications and/or other evidence of the occurrence of illness and/or disease. Disease characteristics and/or disease symptoms may further include other medical signs indicating the nature of a disease and/or illness. Some other examples of disease characteristics and/or disease symptoms may include chest pains indicating heart attack, skin discoloration and or abnormal skin growths indicating a likelihood of skin cancer, and/or jaundice indicating a likelihood of liver disease. Further, operation 2538 illustrates receiving data indicating at least one of a disease progression state or a diagnosis. For example, as shown in FIG. 1, receiver module 102 may receive data indicating at least one of a disease progression state or a diagnosis. In one specific instance, receiver module 102 receives from database entry 114 data indicating a disease progression state for lung cancer. A disease progression state may include an indication of the stage of development for a disease and may include an estimated time left until death for at least one individual. A diagnosis may include the identification of a disease from signs, symptoms, laboratory tests, radiological results and/or physical findings. In some instances, receiver module 102 may include a computer processor.

FIG. 25G illustrates alternative embodiments of the example operational flow 200 of FIG. 2. FIG. 25G illustrates example embodiments where the receiving at least one correlation of epigenetic information associated with at least a first individual for at least a first epigenetic-information interval of time with disability data associated with at least a first individual for at least a first disability-data interval of time operation 220 may include at least one additional operation. Additional operations may include an operation 2540, an operation 2542, an operation 2544, and/or an operation 2546.

Operation 2540 illustrates receiving data including at least one physical disability. For example, as shown in FIG. 1, receiver module 102 may receive data including at least one physical disability. In one specific instance, receiver module 102 receives from memory device 112 data including a physical disability. A physical disability may include physical impairment, sensory impairment, chronic disease, as well as other impairment to body structure and/or impairment to body function. In some instances, receiver module 102 may include a computer processor.

Operation 2542 illustrates receiving data including at least one mental disability. For example, as shown in FIG. 1, receiver module 102 may receive data including at least one mental disability. In one specific instance, receiver module 102 receives from network storage 110 data including a mental disability. A mental disability may include a mental impairment that limits one or more major life activities of the person with the mental impairment. Examples of a mental disability and/or a mental impairment may include depression, mania, bipolar disorder, mental retardation, learning difficulty, mood disorders, anxiety disorders, psychotic disorders, eating disorders, personality disorders, as well as many other disabilites. In some instances, receiver module 102 may include a computer processor.

Operation 2544 illustrates receiving data including at least one emotional disability. For example, as shown in FIG. 1, receiver module 102 may receive data including at least one emotional disability. In one instance, receiver module 102 receives from network storage 110 data including an emotional disability. An emotional disability may include a condition that, over a certain time period and to a marked degree, consistently interferes with a learning ability. An emotional disability may often occur in children and/or adolescents. In some instances, receiver module 102 may include a computer processor.

Operation 2546 illustrates receiving data including at least one late emerging genetic effect. For example, as shown in FIG. 1, receiver module 102 may receive data including at least one late emerging genetic effect. In one specific instance, receiver module 102 receives data including a late emerging genetic effect including a disposition for Parkinson's disease. A late emerging effect may include effects, occurring after a certain period of time not having the effect, resulting from genetic, epigenetic, environmental, and/or other factors. The effects may include disease, illness, side reactions, physical disability, emotional disability, mental disability, and/or other types of impairment. In some instances, receiver module 102 may include a computer processor.

FIG. 25H illustrates alternative embodiments of the example operational flow 200 of FIG. 2. FIG. 25H illustrates example embodiments where the receiving at least one correlation of epigenetic information associated with at least a first individual for at least a first epigenetic-information interval of time with disability data associated with at least a first individual for at least a first disability-data interval of time operation 220 may include at least one additional operation. Additional operations may include an operation 2548, an operation 2550, and/or an operation 2552.

Operation 2548 illustrates receiving disability data on a subscription basis. For example, as shown in FIG. 1, receiver module 102 may receive disability data on a subscription basis. In one specific instance, receiver module 102 receives disability data on a subscription basis. A subscription may include an agreement to receive and/or be given access to the disability data. The subscription may include access to disability data in a digital form and/or a physical form of information, such as paper printouts. In some instances, receiver module 102 may include a computer processor.

Operation 2550 illustrates receiving disability data in the form of a database. For example, as shown in FIG. 1, receiver module 102 may receive disability data in the form of a database. In one specific example, receiver module 102 receives disability data relating to a mental disability in the form of a database. A database may include a collection of data organized for convenient access. The database may include information digitally stored in a memory device 112, as at least a portion of at least one database entry 114, and/or in network storage 110. In some instances, the database may include information stored non-digitally such as at least a portion of a book, a paper file, and/or a non-computerized index and/or catalog. Non-computerized information may be received by receiver module 102 by scanning or manually entering the information into a digital format. In some instances, receiver module 102 may include a computer processor.

Operation 2552 illustrates receiving anonymized disability data. For example, as shown in FIG. 1, receiver module 102 may receive anonymized disability data. In a specific example, receiver module 102 receives disability data indicating an emotional disability anonymized by the use of cell suppression. Anonymized epigenetic information may be anonymized in different degrees and by different methods. Different degrees of anonymization may include full anonymization and/or partial anonymization, such as in the case of pseudonym utilization. Methods for anonymizing epigenetic information may include the use of cell suppression and/or utilizing anonymization algorithms. In some instances, receiver module 102 may include a computer processor.

FIG. 251 illustrates alternative embodiments of the example operational flow 200 of FIG. 2. FIG. 251 illustrates example embodiments where the operation 220 may include at Least one additional operation. Additional operations may include an operation 2554, an operation 2556, and/or an operation 2558. Further, operation 2554 illustrates tracking at least one change in an epigenetic profile associated with the at least a first individual. For example, as shown in FIG. 1, tracker module 140 may track at least one change in an epigenetic profile associated with the at least a first individual. In a specific instance, tracker module 140 tracks changes in an epigenetic profile associated with a first individual named Roger Wheeler. Tracking at least one change in an epigenetic profile may include togging epigenetic information and/or characteristics at multiple points in time for at least one individual. For example, tracking at least one change in an epigenetic profile may include tracking a modification to a histone structure and/or methylation of a DNA structure. In some instances, tracker module 140 may include a computer processor. Then, operation 2556 illustrates tracking at least one change in a disability data profile associated with the at least a first individual. For example, as shown in FIG. 1, tracker module 140 may track at least one change in a disability data profile associated with the at Least a first individual. In a specific example and continuing with the example above, tracker module 140 tracks at least one change in a disability data profile associated with a first individual named Roger Wheeler. Tracking at least one change in a disability data profile may include togging disability data and/or characteristics at multiple points in time for at least one individual. In some instances, tracker module 140 may include a computer processor. Then, operation 2558 illustrates correlating the at least one change in the epigenetic profile associated with the at least a first individual with the at least one change in the disability data profile associated with the at least a first individual. For example, as shown in FIG. 1, correlator module 142 may correlate the at least one change in the epigenetic profile associated with the at least a first individual with the at least one change in the disability data profile associated with the at least a first individual. In one instance and continuing with the example above, correlator module 142 correlates the changes in an epigenetic profile for a first individual named Roger Wheeler with disability data profile associated with Roger White. In some instances, correlator module 142 may include a computer processor.

FIG. 25J illustrates alternative embodiments of the example operational flow 200 of FIG. 2. FIG. 25J illustrates example embodiments where the operation 220 may include at least one additional operation. Additional operations may include an operation 2560 and/or an operation 2562. Further, operation 2560 illustrates compiling epigenetic information associated with at least a specific individual until the at least a first individual is deceased. For example, as shown in FIG. 1, compiler module 144 may compile epigenetic information associated with at least a specific individual for at least a first epigenetic-information interval of time until the at least a first individual is deceased. In one instance, compiler module 144 compiles epigenetic information associated with a specific individual named William Johnson indicating a specific histone structure modification for a period of time spanning from Jun. 1, 1990 until Jul. 1, 2004 when a first individual named Terry Johnson is deceased. In some instances, compiler module 144 may include a computer processor. Further, operation 2562 illustrates compiling epigenetic information associated with at least a second individual until the at least a second individual is deceased for at least a second epigenetic-information interval of time. For example, as shown in FIG. 1, compiler module 144 may compile epigenetic information associated with at least a second individual for at least a second epigenetic-information interval of until the at least a second individual is deceased. In one specific instance, compiler module 144 compiles epigenetic information associated with at a second individual named George Anderson for a time spanning from Apr. 1, 1997, until George Anderson dies on Apr. 1, 2007. In some instances, compiler module 144 may include a computer processor.

FIG. 25K illustrates alternative embodiments of the example operational flow 200 of FIG. 2. FIG. 25K illustrates example embodiments where the operation 220 may include at least one additional operation. Additional operations may include an operation 2564 and/or an operation 2566. Further, operation 2564 illustrates compiling disability data until the at least first individual is deceased. For example, as shown in FIG. 1, compiler module 144 may compile disability data associated with at least a first individual for at least a first disability-data interval of time until the at least first individual is deceased. In one specific instance, compiler module 144 compiles disability data including mental disability associated with at least a first individual named Tom Smith for a time period from May 1, 1995 until Tom Smith dies on May 1, 2005. In some instances, compiler module 144 may include a computer processor. Further, operation 2566 illustrates compiling disability data for at least a second individual until the at least a second individual is deceased for at least a second disability-data interval of time. For example, as shown in FIG. 1, compiler module 144 may compile disability data for at least a second individual until the at least a second individual is deceased for at least a second disability-data interval of time. In one specific instance and continuing with the example above, compiler module 144 compiles disability data for a first individual named Tom Smith and a second individual named John Smith from Jan. 1, 1998 until John Smith dies on Jan. 26, 2006. In some instances, compiler module 144 may include a computer processor.

FIG. 25L illustrates alternative embodiments of the example operational flow 200 of FIG. 2. FIG. 25L illustrates example embodiments where the operation 220 may include at least one additional operation. Additional operations may include an operation 2568 and/or an operation 2570. Further, operation 2568 illustrates determining a statistical correlation between at least one aspect of the epigenetic profile and the disability data profile. For example, as shown in FIG. 1, determiner module 146 may determine a statistical correlation between at least one aspect of the epigenetic profile and the disability data profile. In a specific instance, determiner module 146 determines a statistical correlation between an aspect of the epigenetic profile and an aspect in a disability data profile. A statistical correlation may indicate the strength and direction of a linear relationship between two variables, such as epigenetic information data and/or disability data. In some instances, a determiner module 146 may include a computer processor. Further, operation 2570 illustrates determining a statistical correlation between at least one aspect of the epigenetic profile and the disability data profile for the at least a first individual and at least a second individual. For example, as shown in FIG. 1, determiner module 146 may determine a statistical correlation between at least one aspect of the epigenetic profile and the disability data profile for the at least a first individual and at least a second individual. In a specific instance, determiner module 146 determines a statistical correlation between at least one aspect of the epigenetic profile including a change in histone structure and a disability data profile for a first individual named Bill Norton and a second individual named Fred Jones. In some instances, determiner module 146 may include a computer processor.

FIG. 25M illustrates alternative embodiments of the example operational flow 200 of FIG. 2. FIG. 25M illustrates example embodiments where the operation 220 may include at least one additional operation. Additional operations may include an operation 2572 and/or an operation 2574. Further, operation 2572 illustrates utilizing at least one of a linear correlation, a non-linear correlation, a functional dependency, or another mathematical relationship. For example, as shown in FIG. 1, utilizer module 148 may utilize at least one of a linear correlation, a non-linear correlation, a functional dependency, or another mathematical relationship. In one example, utilizer module 148 utilizes a linear correlation. A linear correlation may include a relationship between variables where the changes in one variable are proportional to changes in the other variable. A non-linear correlation may include a relationship between variables where the changes in one variable are not proportional to changes in the other variable. A functional dependency may exist when one variable is fully determined by another variable. In some instances, utilizer module 148 may include a computer processor. Further, operation 2574 illustrates counting at least one occurrence of at least one clinical outcome. For example, as shown in FIG. 1, counter module 150 may count at least one occurrence of at least one clinical outcome. In a specific instance, counter module 150 counts the occurrences of a clinical outcome including admittance to a hospital and/or a gene mutation. Counting an occurrence of at least one clinical outcome may include counting a single or multiple occurrences of an outcome, such as, for example, a genomic imprinting, a gene mutation, and/or a certain phenotype. In some instances, counter module 150 may include a computer processor.

FIG. 25N illustrates an operational flow 2500 representing example operations related to providing to a third party information including at least one of epigenetic information associated with at least a specific individual correlated with at least one correlation of epigenetic information associated with at least a first individual for at least a first epigenetic-information interval of time with disability data associated with at least a first individual for at least a first disability-data interval of time; at least one correlation of epigenetic information associated with at least a specific individual and other information; at least one correlation of epigenetic information associated with at least a specific individual and characteristic information; or a prognosticated risk. FIG. 25N illustrates an example embodiment where the example operational flow 200 of FIG. 2 may include at least one additional operation. Additional operations may include an operation 2576, an operation 2578, and/or an operation 2580.

After a start operation, a receiving epigenetic information associated with at least a specific individual operation 210, a receiving at least one correlation of epigenetic information associated with at least a first individual for at least a first epigenetic-information interval of time with disability data associated with at least a first individual for at least a first disability-data interval of time operation 220, and a prognosticating a risk at least partially based on the epigenetic information associated with at least a specific individual and the at Least one correlation of epigenetic information associated with at least a first individual for at least a first epigenetic-information interval of time with disability data associated with at least a first individual for at least a first disability-data interval of time operation 230, the operational flow 2500 moves to a providing to a third party information including at least one of epigenetic information associated with at least a specific individual correlated with at least one correlation of epigenetic information associated with at least a first individual for at least a first epigenetic-information interval of time with disability data associated with at least a first individual for at least a first disability-data interval of time; at least one correlation of epigenetic information associated with at least a specific individual and other information; at least one correlation of epigenetic information associated with at least a specific individual and characteristic information; or a prognosticated risk operation 2576. For example, as shown in FIG. 1, provider module 136 may provide to a third party correlated information including the epigenetic information associated with at least a specific individual and epigenetic information associated with at least a first individual for at least a first epigenetic-information interval of time with disability data associated with at least a first individual for at least a first disability-data interval of time. In a specific instance, provider module 136 provides correlated information including epigenetic information associated with a specific individual named Thomas Smith and epigenetic information associated with a first group of individuals living within a five mile radius of a nuclear reactor from a period of time starting Jan. 1, 1985 and ending Jan. 1, 2000 and disability data associated with the same first group of individuals for the same period of time to a third party including a university. In some instances, provider module 136 may include a computer processor.

Operation 2578 illustrates providing the correlated information to at least one of an insurer or a legal professional. For example, as shown in FIG. 1, provider module 136 may supply the correlated information to at least one of an insurer or a legal professional. In one specific instance, provider module 136 supplies the correlated information to an insurer. In another specific instance, provider module 136 supplies the correlated information to a legal professional. An insurer may include a company or an entity that issues a contract for insurance, including health insurance, life insurance, disability insurance, and/or other types of insurance. A legal professional may include an attorney, a paralegal, a law firm, an in-house counsel, a contractor or other entity hired by a legal professional, and/or other entities dealing with the practice or enforcing the law. In some instances, provider module 136 may include a computer processor.

Operation 2580 illustrates providing the correlated information to at least one of a health agency or a medical professional. For example, as shown in FIG. 1, provider module 136 may provide the correlated information to at least one of a health agency or a medical professional. In a specific instance, provider module 136 provides the correlated information a health agency. A health agency may include any governmental unit, business, and/or other entity that relates to health. In another specific instance, provider module 136 provides the correlated information a medical professional. A medical professional may include a physician, a nurse, a pharmacist, a physical therapist, a hospital administrator and/or administration staff, an entity hired/employed by a medical professional, and/or other entities dealing with practicing and/or providing medical care. In some instances, provider module 136 may include a computer processor.

FIG. 250 illustrates alternative embodiments of the example operational flow 2500 of FIG. 25N. FIG. 250 illustrates example embodiments where the providing to a third party information including at least one of epigenetic information associated with at least a specific individual correlated with at least one correlation of epigenetic information associated with at least a first individual for at least a first epigenetic-information interval of time with disability data associated with at least a first individual for at least a first disability-data interval of time; at least one correlation of epigenetic information associated with at least a specific individual and other information; at least one correlation of epigenetic information associated with at least a specific individual and characteristic information; or a prognosticated risk operation 2576 may include at least one additional operation. Additional operations may include an operation 2582 and/or an operation 2584.

Operation 2582 illustrates providing the correlated information to an academic institution. For example, as shown in FIG. 1, provider module 136 may provide the correlated information to an academic institution. In one example, provider module 136 provides the correlated information to a research university. An academic institution may include a public and/or private educational institution, which may grant academic degrees. In some instances, provider module 136 may include a computer processor.

Operation 2584 illustrates providing the correlated information to at least one of the specific individual or a second individual. For example, as shown in FIG. 1, provider module 136 may provide the correlated information to at least one of the first individual or a second individual. In a specific instance, provider module 136 provides the correlated information to a first individual named John Gates and a second individual named Frank Jones. The first individual and the second individual may or may not have a blood relationship and/or a familial relationship. In some instances, provider module 136 may include a computer processor.

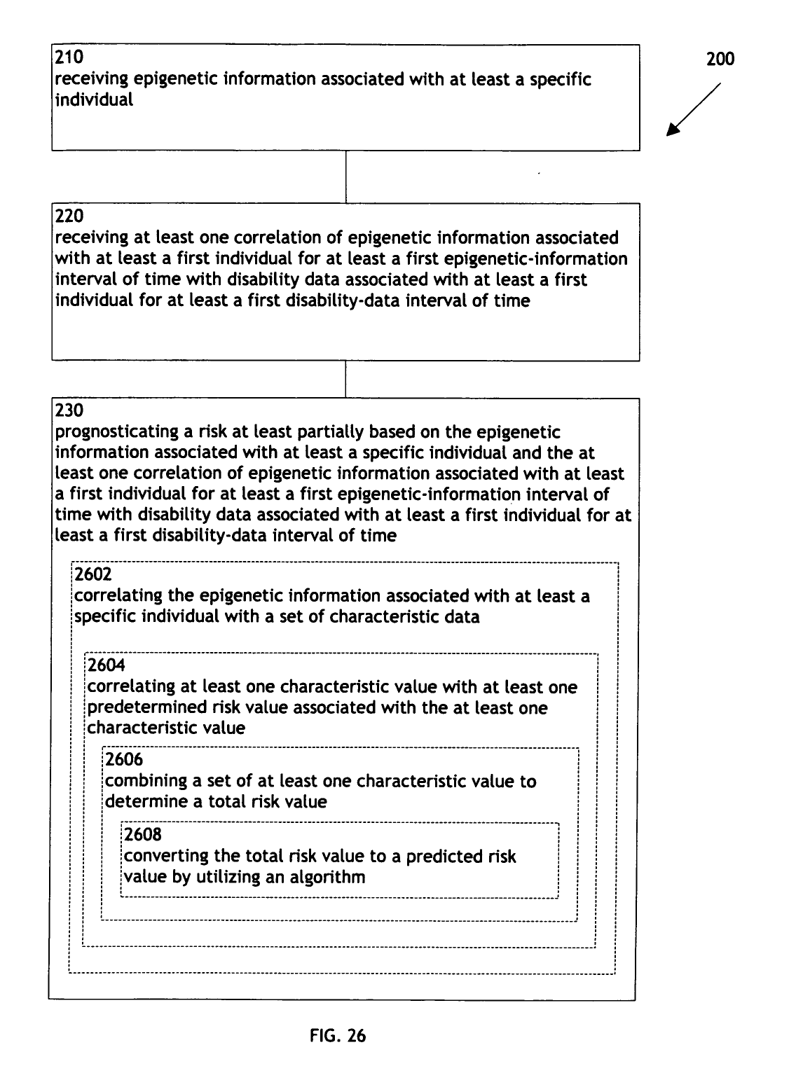

FIG. 26 illustrates alternative embodiments of the example operational flow 200 of FIG. 2. FIG. 26 illustrates example embodiments where the operation 230 may include at least one additional operation. Additional operations may include an operation 2602, an operation 2604, an operation 2606, and/or an operation 2608.

Operation 2602 illustrates correlating the epigenetic information associated with at least a specific individual with a set of characteristic data. For example, as shown in FIG. 1, correlator module 118 may link the epigenetic information associated with at least another individual correlated with other information associated with at least a second individual with the characteristic data 108. In one specific example, correlator module 118 links epigenetic information associated with another individual named Sandy Johnson correlated with other information including dietary information associated with Sandy Johnson's immediate family with characteristic data 108 including an amount of pollution in the location Sandy Johnson resides. In some instances, correlator module 118 may include a computer processor. Further, the operation 2604 illustrates correlating at least one characteristic value with at least one predetermined risk value associated with the at least one characteristic value. For example, as shown in FIG. 1, correlator module 118 may correlate at least one characteristic value with at least one predetermined risk value associated with the at least one characteristic value. In one example, correlator module 118 correlates a characteristic value with a predetermined risk value associated with the characteristic value. A characteristic value may include an index for rating a characteristic, such as an economic and/or health characteristic. An example of a characteristic value may include a number between 1 and 10 with 1 being a weak characteristic and 10 being a strong characteristic based on the strength and/or weakness of the characteristic. A predetermined risk value may include an assigned value that the likelihood a risk will occur (e.g. a characteristic value of 8 may be given for the level of cholesterol a person has resulting in predetermined risk value of 85% likelihood heart disease will occur in the same person). In some instances, correlator module 118 may include a computer processor. Further, the operation 2606 illustrates combining a set of at least one characteristic value to determine a total risk value. For example, as shown in FIG. 1, combiner module 120 may combine a set of at least one characteristic value to determine a total risk value. In one example, combiner module 120 combines a set of five characteristic values and/or predetermined risk values to determine a total risk value. A total risk value may include a single value derived from multiple predetermined risk values, and a predetermined risk value may be derived from characteristic values. In some instances, combiner module 120 may include a computer processor. Further, the operation 2608 illustrates converting the total risk value to a predicted risk value by utilizing an algorithm. For example, as shown in FIG. 1, converter module 122 may convert the total risk value to a predicted risk value by utilizing an algorithm. In one example, converter module 122 converts the total risk value to a predicted risk value by utilizing an algorithm. Some examples of an algorithm may include a mathematical algorithm, a computer algorithm, and/or an algorithm utilizing a differential equation. In some instances, converter module 122 may include a computer processor.

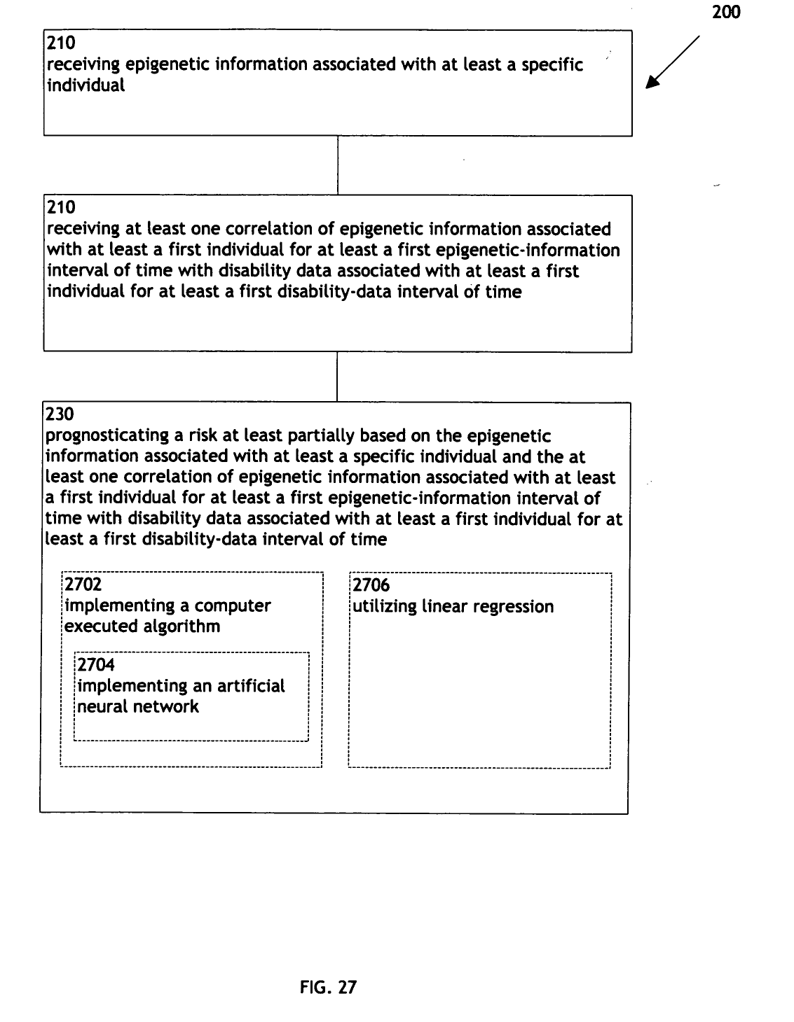

FIG. 27 illustrates alternative embodiments of the example operational flow 200 of FIG. 2. FIG. 27 illustrates example embodiments where the operation 230 may include at least one additional operation. Additional operations may include an operation 2702, an operation 2704, and/or an operation 2706.

Operation 2702 illustrates implementing a computer executed algorithm. For example, as shown in FIG. 1, implementer module 124 may implement a computer executed algorithm. In one example, implementer module 124 implements a computer executed algorithm. A computer executed algorithm may include any algorithm executable by a computer. In some instances, implementer module 124 may include a computer processor. Further, the operation 2704 illustrates implementing an artificial neural network. For example, as shown in FIG. 1, implementer module 124 may implement an artificial neural network. In one instance, implementer module 124 may implement an artificial neural network. An artificial neural network may include a mathematical and/or a computational model based on a biological neural network. Additionally, an artificial neural network may include non-linear statistical data modeling tools. In some instances, implementer module 124 may include a computer processor.

The operation 2706 illustrates utilizing linear regression. For example, as shown in FIG. 1, utilizer module 126 may utilize linear regression. In one example, utilizer module 126 utilizes linear regression for predicting a risk. Linear regression may include the process of fitting the best possible straight line through a series of points and/or finding a best fit of sample data points for a linear model. In some instances, utilizer module 126 may include a computer processor.

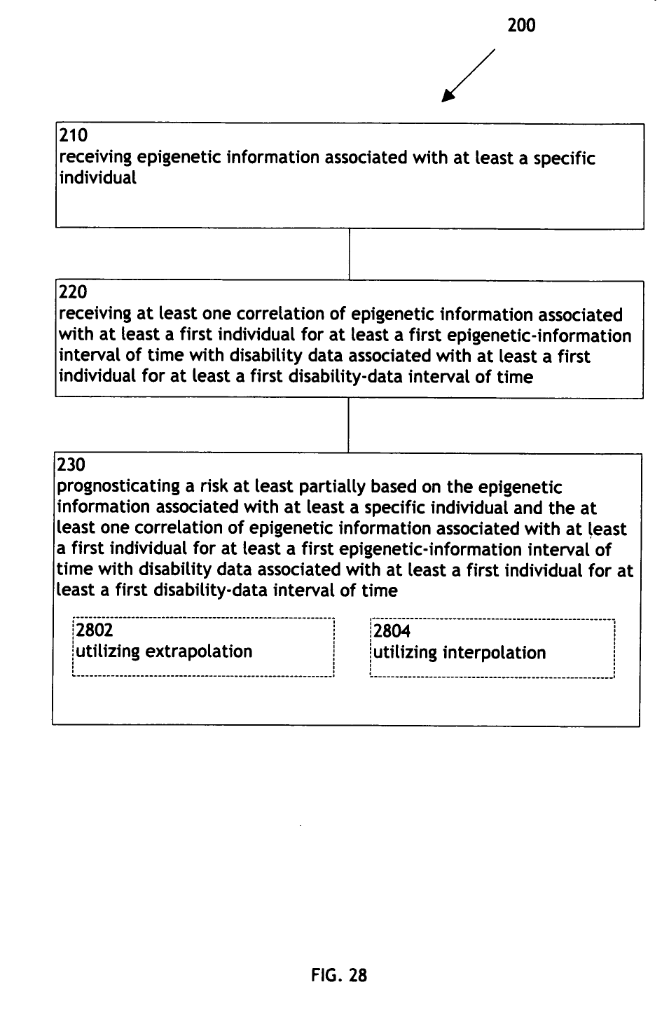

FIG. 28 illustrates alternative embodiments of the example operational flow 200 of FIG. 2. FIG. 28 illustrates example embodiments where the operation 230 may include at least one additional operation. Additional operations may include an operation 2802, and/or an operation 2804.

The operation 2802 illustrates utilizing extrapolation. For example, as shown in FIG. 1, utilizer module 126 may utilize extrapolation. In a specific instance, utilizer module 126 utilizes extrapolation for prognosticating a risk. Extrapolation may include calculating the value of a function outside the range of known values. In some instances, utilizer module 126 may include a computer processor.

The operation 2804 illustrates utilizing interpolation. For example, as shown in FIG. 1, utilizer module 126 may utilize interpolation. In a specific example, utilizer module 126 utilizes interpolation for predicting a certain risk. Interpolation may include a method for constructing new data points within the range of a discrete set of known data points. In some instances, utilizer module 126 may include a computer processor.

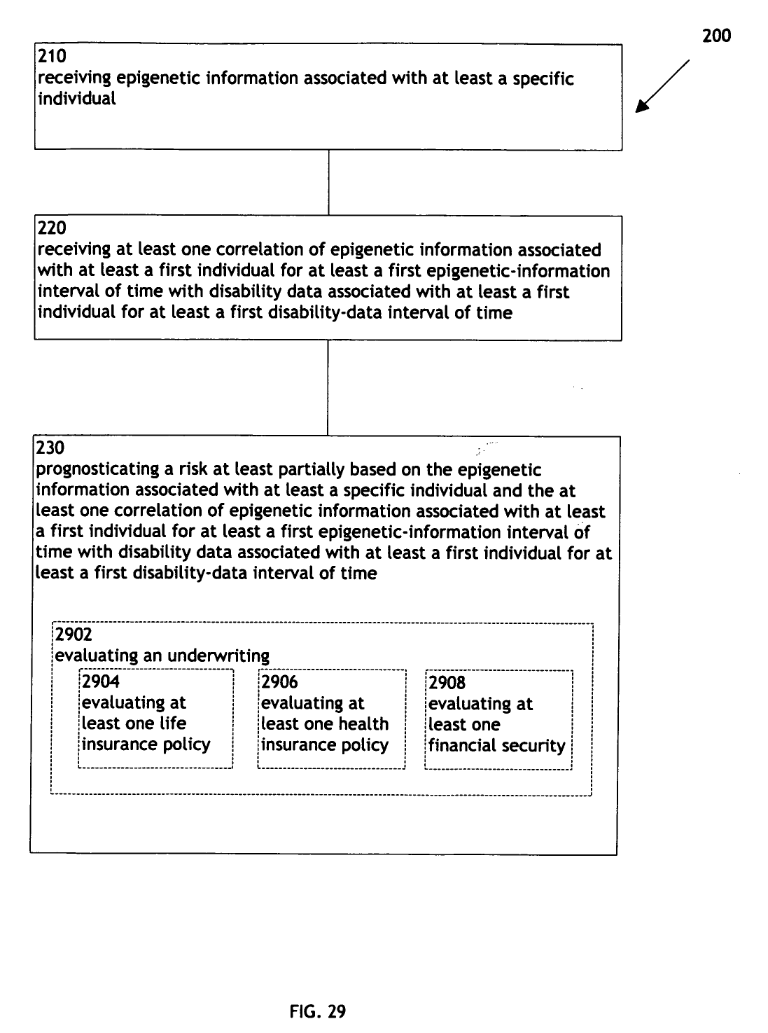

FIG. 29 illustrates alternative embodiments of the example operational flow 200 of FIG. 2. FIG. 29 illustrates example embodiments where the operation 230 may include at least one additional operation. Additional operations may include an operation 2902, an operation 2904, an operation 2906, and/or an operation 2908.

The operation 2902 illustrates evaluating an underwriting. For example, as shown in FIG. 1, evaluator module 128 may evaluate an underwriting. In one specific instance, evaluator module 128 evaluates an underwriting. An underwriting may include an assessment and/or analysis of a certain risk. Examples of an underwriting may include insurance underwriting and/or issuing loans. In some instances, evaluator module 128 may include a computer processor. Further, the operation 2904 illustrates evaluating at least one life insurance policy. For example, as shown in FIG. 1, evaluator module 128 may evaluate at least one life insurance policy. In one example, evaluator module 128 evaluates a group of five hundred life insurance policies. A life insurance policy may include a type of insurance policy that pays a benefit upon the death of an insured person. In some instances, evaluator module 128 may include a computer processor. Further, the operation 2906 illustrates evaluating at least one health insurance policy. For example, as shown in FIG. 1, evaluator module 128 may evaluate at least one health insurance policy. In a specific example, evaluator module 128 evaluates a group of five thousand health insurance policies. In some instances, evaluator module 128 may include a computer processor. Further, the operation 2908 illustrates evaluating at least one financial security. For example, as shown in FIG. 1, evaluator module 128 may evaluate at least one financial security. In one instance, evaluator module 128 evaluates a financial security. A financial security may include a fungible, negotiable interest representing financial value. Examples of a financial security may include stocks, bonds, and/or banknotes. Additionally, evaluating a financial security may include evaluating a primary loan signer, a loan co-signer, a surety, and/or a guarantor of a loan in some instances, evaluator module 128 may include a computer processor.

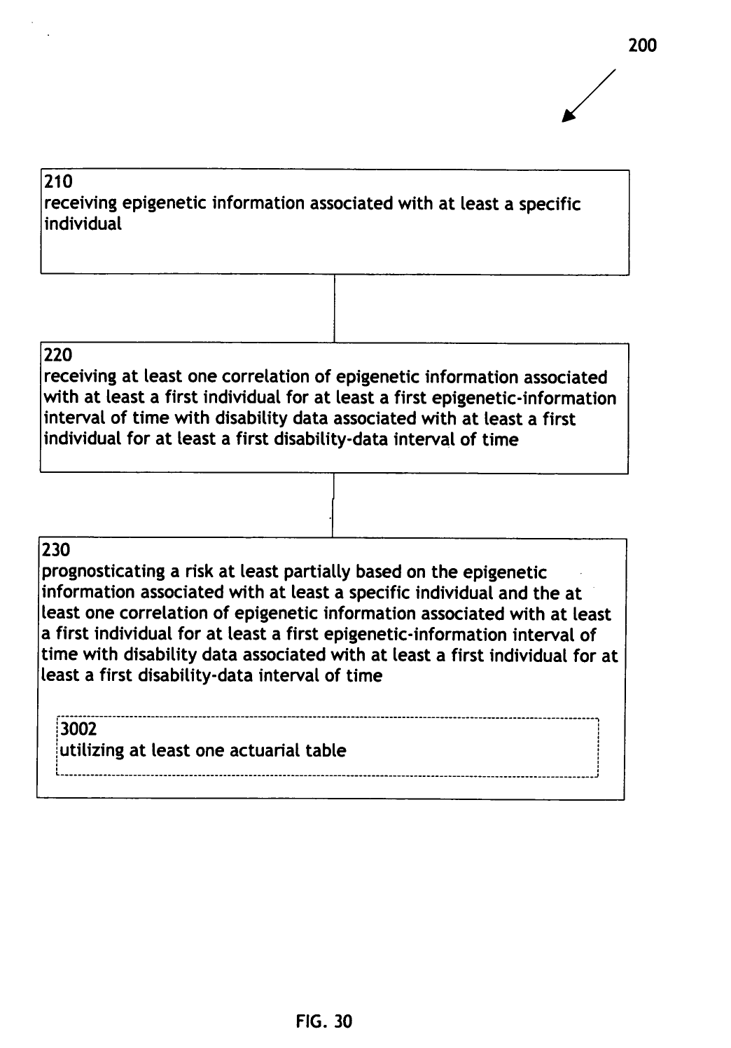

FIG. 30 illustrates alternative embodiments of the example operational flow 200 of FIG. 2. FIG. 30 illustrates example embodiments where the operation 230 may include at least one additional operation. Additional operations may include an operation 3002.

The operation 3002 illustrates utilizing at least one actuarial table. For example, as shown in FIG. 1, utilizer module 126 may utilize at least one actuarial table. In one example, utilizer module 126 utilizes an actuarial table for predicting a risk. An actuarial table may include a table which shows the probability a person will die before their next birthday. In some instances, utilizer module 126 may include a computer processor.

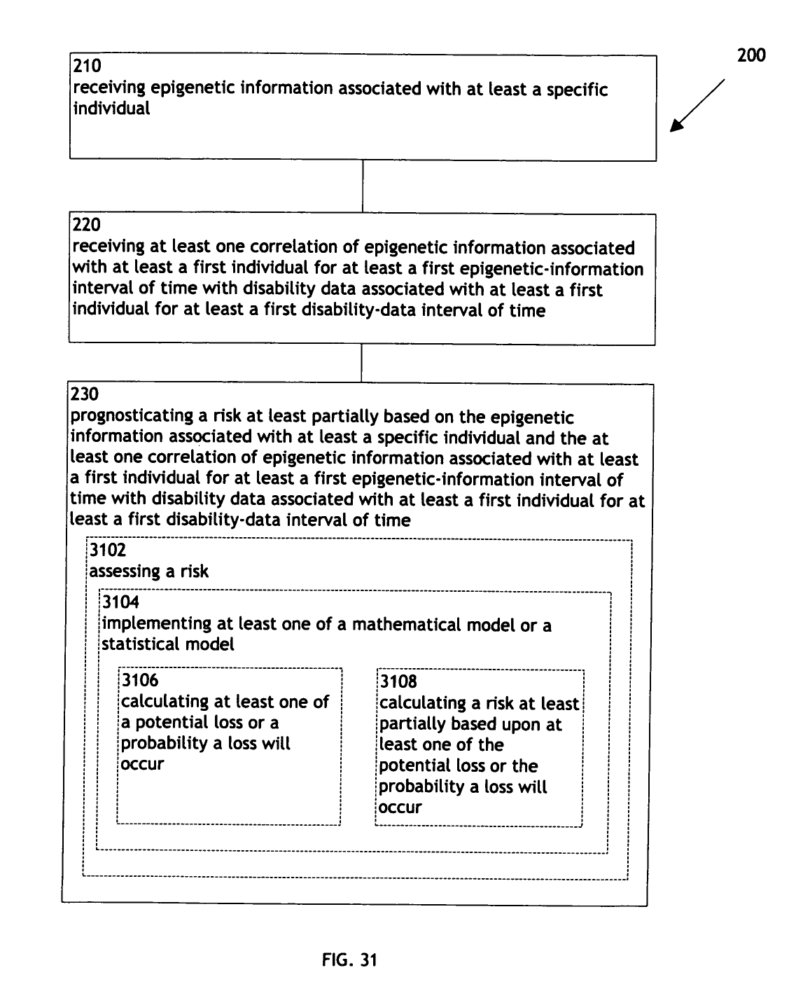

FIG. 31 illustrates alternative embodiments of the example operational flow 200 of FIG. 2. FIG. 31 illustrates example embodiments where the operation 230 may include at least one additional operation. Additional operations may include an operation 3102, an operation 3104, an operation 3106, and/or an operation 3108.

The operation 3102 illustrates correlating the epigenetic information associated with at least a specific individual with a set of characteristic data. For example, as shown in FIG. 1, assessor module 130 may assess a risk. In one example, assessor module 130 may assess a risk. Assessing a risk may include assessing a previously underwritten risk as well as a future risk. In some instances, assessor module 130 may include a computer processor. Further, the operation 3104 illustrates implementing at least one of a mathematical model or a statistical model. For example, as shown in FIG. 1, implementer module 132 may implement at least one of a mathematical model or a statistical model. In one instance, implementer module 132 implements a statistical model utilizing extrapolation. A mathematical model may include an abstract model that uses mathematical language to describe a system. Some examples of mathematical models may include dynamical systems, statistical models, differential equations, and/or game theoretic models. A statistical model may include a model utilizing statistics to describe a system and/or a parameterized set of probability distributions. In some instances, implementer module 132 may include a computer processor. Further, the operation 3106 illustrates calculating at least one of a potential loss or a probability a loss will occur. For example, as shown in FIG. 1, calculator model 134 may calculate at least one of a potential loss or a probability a loss will occur. In one example, calculator model 134 calculates a probability a loss will occur by utilizing a statistical model. A probability a loss will occur may include the likelihood a loss will occur. A potential loss may include the magnitude or amount of a potential loss. In some instances, calculator model 134 may include a computer processor. Further, the operation 3108 illustrates calculating a risk at least partially based upon at least one of the potential loss or the probability a loss will occur. For example, as shown in FIG. 1, calculator model 134 may calculate a risk at least partially based upon at least one of the potential loss or the probability a loss will occur. In a specific instance, calculator model 134 calculates a risk based upon a 13% probability that a loss will occur. In some instances, calculator model 134 may include a computer processor.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures suitable to operation. Electronic circuitry, for example, may manifest one or more paths of electrical current constructed and arranged to implement various logic functions as described herein. In some implementations, one or more media are configured to bear a device-detectable implementation if such media hold or transmit a special-purpose device instruction set operable to perform as described herein. In some variants, for example, this may manifest as an update or other modification of existing software or firmware, or of gate arrays or other programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or otherwise invoking circuitry for enabling, triggering, coordinating, requesting, or otherwise causing one or more occurrences of any functional operations described above. In some variants, operational or other logical descriptions herein may be expressed directly as source code and compiled or otherwise invoked as an executable instruction sequence. In some contexts, for example, C++ or other code sequences can be compiled directly or otherwise implemented in high-level descriptor languages (e.g., a logic-synthesizable language, a hardware description language, a hardware design simulation, and/or other such similar mode(s) of expression). Alternatively or additionally, some or all of the logical expression may be manifested as a Verilog-type hardware description or other circuitry model before physical implementation in hardware, especially for basic operations or timing-critical applications. Those skilled in the art will recognize how to obtain, configure, and optimize suitable transmission or computational elements, material supplies, actuators, or other common structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs. Those skilled in the art will also appreciate that examples of electromechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art wilt recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1. A computer-implemented method, comprising:
receiving epigenetic information associated with at least a specific individual;
receiving at least one correlation of epigenetic information associated with at least a first individual for at least a first epigenetic-information interval of time with disability data associated with at least a first individual for at least a first disability-data interval of time; and
prognosticating a risk at least partially based on the epigenetic information associated with at least a specific individual and the at least one correlation of epigenetic information associated with at least a first individual for at least a first epigenetic-information interval of time with disability data associated with at least a first individual for at least a first disability-data interval of time.

2-109. (canceled)

110. A system, comprising:
means for receiving epigenetic information associated with at least a specific individual;
means for receiving at least one correlation of epigenetic information associated with at least a first individual for at least a first epigenetic-information interval of time with disability data associated with at least a first individual for at least a first disability-data interval of time; and
means for prognosticating a risk at least partially based on the epigenetic information associated with at least a specific individual and the at least one correlation of epigenetic information associated with at least a first individual for at least a first epigenetic-information interval of time with disability data associated with at least a first individual for at least a first disability-data interval of time.

111. The system of claim 110, wherein means for receiving epigenetic information associated with at least a specific individual comprises:
means for receiving the epigenetic information associated with at least a specific individual in the form of a database.

112. The system of claim 110, wherein means for receiving epigenetic information associated with at least a specific individual comprises:
means for receiving a first set of the epigenetic information associated with at least a specific individual; and
means for receiving a second set of the epigenetic information associated with at least a specific individual.

113. The system of claim 112, further comprising:
means for receiving a third set of the epigenetic information associated with at least a specific individual.

114. The system of claim 110, wherein means for receiving epigenetic information associated with at least a specific individual comprises:
means for receiving information including a cytosine methylation status of CpG positions.

115. The system of claim 110, wherein means for receiving epigenetic information associated with at least a specific individual comprises:
means for receiving information including histone modification status.

116. The system of claim 110, wherein means for receiving epigenetic information associated with at least a specific individual comprises:
means for receiving the epigenetic information associated with at least a specific individual on a subscription basis.

117. The system of claim 110, wherein means for receiving epigenetic information associated with at least a specific individual comprises:
means for receiving anonymized epigenetic information associated with at least a specific individual.

118. The system of claim 110, wherein means for receiving epigenetic information associated with at least a specific individual comprises:
means for receiving other information including disability information.

119-126. (canceled)

127. The system of claim 110, wherein means for receiving epigenetic information associated with at least a specific individual comprises:
means for receiving characteristic data.

128-132. (canceled)

133. The system of claim 127, wherein means for receiving characteristic data comprises:
means for receiving personal data.

134-141. (canceled)

142. The system of claim 127, wherein means for receiving characteristic data comprises:
means for receiving characteristic data including environmental data.

143-150. (canceled)

151. The system of claim 127, wherein means for receiving characteristic data comprises:
means for receiving characteristic data including economic data.

152-164. (canceled)

165. The system of claim 110, wherein means for receiving at least one correlation of epigenetic information associated with at least a first individual for at least a first epigenetic-information interval of time with disability data associated with at least a first individual for at least a first disability-data interval of time comprises:
means for receiving epigenetic information associated with at least a first individual for at least a first epigenetic-information interval of time;
means for receiving disability data associated with at least a first individual for at least a first disability-data interval of time; and
means for correlating the epigenetic information associated with at least a first individual for at least a first epigenetic-information interval of time with the disability data associated with at least a first individual for at least a first disability-data interval of time.

166-176. (canceled)

177. The system of claim 165, wherein means for receiving disability data associated with at least a first individual for at least a first disability-data interval of time comprises:
means for receiving at least one of disease data or illness data.

178-179. (canceled)

180. The system of claim 165, wherein means for receiving disability data associated with at least a first individual for at least a first disability-data interval of time comprises:
means for receiving data including at least one physical disability.

181. The system of claim 165, wherein means for receiving disability data associated with at least a first individual for at least a first disability-data interval of time comprises:
means for receiving data including at least one mental disability.

182-186. (canceled)

187. The system of claim 165, wherein means for correlating the epigenetic information associated with at least a first individual for at least a first epigenetic-information interval of time with the disability data associated with at least a first individual for at least a first disability-data interval of time comprises:
means for tracking at least one change in an epigenetic profile associated with the at least a first individual;
means for tracking at least one change in a disability data profile associated with the at least a first individual; and
means for correlating the at least one change in the epigenetic profile associated with the at least a first individual with the at least one change in the disability data profile associated with the at least a first individual.

188-191. (canceled)

192. The system of claim 187, wherein means for correlating the at least one change in the epigenetic profile associated with the at least a first individual with the at least one change in the disability data profile associated with the at least a first individual comprises:
means for determining a statistical correlation between at least one aspect of the epigenetic profile and the disability data profile.

193-200. (canceled)

201. The system of claim 110, wherein means for prognosticating a risk at least partially based on the epigenetic information associated with at least a specific individual and the at least one correlation of epigenetic information associated with at least a first individual for at least a first epigenetic-information interval of time with disability data associated with at least a first individual for at least a first disability-data interval of time comprises:
means for correlating the epigenetic information associated with at least a specific individual with a set of characteristic data.

202-204. (canceled)

205. The system of claim 110, wherein means for prognosticating a risk at least partially based on the epigenetic information associated with at least a specific individual and the at least one correlation of epigenetic information associated with at least a first individual for at least a first epigenetic-information interval of time with disability data associated with at least a first individual for at least a first disability-data interval of time comprises:
means for implementing a computer executed algorithm.

206. The system of claim 205, wherein means for implementing a computer executed algorithm comprises:
means for implementing an artificial neural network.

207. The system of claim 110, wherein means for prognosticating a risk at least partially based on the epigenetic information associated with at least a specific individual and the at least one correlation of epigenetic information associated with at least a first individual for at least a first epigenetic-information interval of time with disability data associated with at least a first individual for at least a first disability-data interval of time comprises:
means for utilizing linear regression.

208. The system of claim 110, wherein means for prognosticating a risk at least partially based on the epigenetic information associated with at least a specific individual and the at least one correlation of epigenetic information associated with at least a first individual for at least a first epigenetic-information interval of time with disability data associated with at least a first individual for at least a first disability-data interval of time comprises:
means for utilizing extrapolation.

209. The system of claim 110, wherein means for prognosticating a risk at least partially based on the epigenetic information associated with at least a specific individual and the at least one correlation of epigenetic information associated with at least a first individual for at least a first epigenetic-information interval of time with disability data associated with at least a first individual for at least a first disability-data interval of time comprises:
means for utilizing interpolation.

210. The system of claim 110, wherein means for prognosticating a risk at least partially based on the epigenetic information associated with at least a specific individual and the at least one correlation of epigenetic information associated with at least a first individual for at least a first epigenetic-information interval of time with disability data associated with at least a first individual for at least a first disability-data interval of time comprises:
means for evaluating an underwriting.

211-213. (canceled)

214. The system of claim 110, wherein means for prognosticating a risk at least partially based on the epigenetic information associated with at least a specific individual and the at least one correlation of epigenetic information associated with at least a first individual for at least a first epigenetic-information interval of time with disability data associated with at least a first individual for at least a first disability-data interval of time comprises:
means for utilizing at least one actuarial table.

215. The system of claim 110, wherein means for prognosticating a risk at least partially based on the epigenetic information associated with at least a specific individual and the at least one correlation of epigenetic information associated with at least a first individual for at least a first epigenetic-information interval of time with disability data associated with at least a first individual for at least a first disability-data interval of time comprises:
means for assessing a risk.

216. The system of claim 215, wherein means for assessing a risk comprises:
means for implementing at least one of a mathematical model or a statistical model.

217. The system of claim 216, wherein means for implementing at least one of a mathematical model or a statistical model comprises:
means for calculating at least one of a potential loss or a probability a loss will occur.

218. The system of claim 217, further comprising:
means for calculating a risk at least partially based upon at least one of the potential loss or the probability a loss will occur.

219. A system, comprising:
circuitry for receiving epigenetic information associated with at least a specific individual;
circuitry for receiving at least one correlation of epigenetic information associated with at least a first individual for at least a first epigenetic-information interval of time with disability data associated with at least a first individual for at least a first disability-data interval of time; and
circuitry for prognosticating a risk at least partially based on the epigenetic information associated with at least a specific individual and the at least one correlation of epigenetic information associated with at least a first individual for at least a first epigenetic-information interval of time with disability data associated with at least a first individual for at least a first disability-data interval of time.
